(19) United States
(12) Patent Application Publication
(10) Pub. No.: US 2007/0172180 A1
(43) Pub. Date: Jul. 26, 2007

(54) CONFOCAL IMAGE GUIDE

(75) Inventors: Russell B. Pillers, Sparks, NV (US); Nelson George Publicover, Reno, NV (US)

Correspondence Address: KLARQUIST SPARKMAN, LLP, 121 SW SALMON STREET, SUITE 1600, PORTLAND, OR, 97204, US

(73) Assignee: The Board of Regents of the Nevada System of Higher Education

(21) Appl. No.: 11/625,721

(22) Filed: Jan. 22, 2007

Related U.S. Application Data
(60) Provisional application No. 60/760,609, filed on Jan. 20, 2006.

(51) Int. Cl. G02B 6/04; G02B 6/06

(52) U.S. Cl. 385/115; 385/116

(57) ABSTRACT

In certain aspects, the present disclosure provides image guides having a plurality of spaced-apart optical fibers. The fibers are spaced apart sufficiently to allow parallel pixel acquisition from at least a portion of the plurality of fibers. In some examples, the fibers are encased in a rigid matrix. The image guides are, in some examples, enclosed in a rigid material. In specific examples, the rigid material is flexible, allowing the image guide to bend or flex. Further provided are methods for fabricating such image guides. According to a particular method, fibers in an image guide are individually mobilized. A portion of the image guide is heated until the mobilized fibers obtain a plastic state. The image guide is then drawn, cooled, and axially cut. The fiber ends may be ground or polished to obtain fibers of a particular diameter or desired surface characteristics.

### CROSS REFERENCE TO RELATED APPLICATIONS

This application claims the benefit of, and incorporates by reference, U.S. Provisional Patent Application No. 60/760,609 filed Jan. 20, 2006.

### TECHNICAL FIELD

The present disclosure relates image guides, their methods of production, and systems and apparatus incorporating such image guides. In particular examples, the present disclosure provide an image guide having an end having a plurality of spaced apart, or small diameter, strand ends.

### BACKGROUND

Confocal endoscopy is an emerging technology that provides the ability to obtain ‘slices’ of deep, in vivo biological tissues with minimally invasive tools. Confocal imaging optically ‘slices’ tissues or other semi-transparent materials without causing the substantial damage associated with mechanical sectioning. Because confocal imaging does not cause mechanical damage, its application in vivo is a logical progression. Until recently, confocal imaging of in vivo structures has been limited to those easily accessible with laboratory microscopes, such as the cornea of the eye or the surface of the brain. In the early 1990's efforts were made to implement confocal microscopy in an endoscopic format. Long, slender endoscopes, using either rigid or flexible image guide, facilitate the internal examination of a number of organs deep within subjects or patients.

Confocal imaging typically relies on careful placement of very small aperture(s) in the optic path of a microscope (FIG. 1) such that the apertures reject almost all out-of-focus light generated in a sample. The pinholes create an ability to view thin optical ‘slices’ located some depth into a sample.

Two developmental events in the history of confocal microscopy are worthy of note as they illustrate attempts to solve problems with confocal imaging that are still with us today. The pinhole in Minsky's original design captured information from only one ‘spot’ at a time; therefore, Petran incorporated a spinning Nipkow disk in an attempt to generate a real-time full-field image of the focal plane. Unfortunately, the widely spaced holes in a Nipkow disk typically permit only 1-2% of source light to reach a sample. This bottleneck puts immense pressure on the rest of the system to efficiently capture the small volume of light returning from the sample. The Minsky design moved the sample stage in order to assemble an image from the single illuminated spot. Stage scanning itself presents a host of problems, most of which are related to stage motion physics.

In an attempt to alleviate this problem, Davidovits and Eggar developed an idea of scanning a laser back and forth to construct an image while leaving the sample still.³ Laser scanning introduces new challenges involving optics required to re-aim the beam for each spot in the image. These two benchmark methods highlight issues that have yet to be adequately solved in many confocal designs—full frame imaging and image acquisition speed.

A short time after single fibers were first used confocally, it was realized that the fiber could allow the objective to be remotely located far enough from the scanning hardware such that minimally invasive, in vivo confocal imaging was possible. To be applicable in endoscopic form, mechanisms responsible for confocal operation require significant adaptation. Early confocal endoscopes, or conscopes, use one of two methods. Scanning hardware located toward the distal tip of the scope can be used to raster scan a single fiber across the back of an objective. In the second technique a laser is scanned using mechanics outside the body over the proximal end of a fiber bundle. Both of these methods generate only one pixel at a time for image reconstruction. Although confocal endoscopes are beginning to make an entrance into the clinical environment, complex scanning systems limit each of the current designs.

The Giniúnas endoscope uses a single fiber design similar to those in early confocal microscope designs. The Giniúnas design placed the scanning mechanics at the distal end of a single fiber. Giniúnas's endoscope functions by scanning the fiber's distal face across the proximal end of a long, rod-lens objective. The objective provided separation of scanning hardware and distal endoscope face. Therefore, the minimally invasive nature of the scope was derived from the objective, not the fiber.

The second confocal endoscope design methodology used a coherent image bundle. A fiber optic image bundle is fabricated by bonding thousands of optical fibers together such that any image striking one end of the fiber is faithfully relayed to the other end (FIG. 2). Typical endoscopic designs using image guide (IG) in a confocal endoscope design merely replace the mechanical scanner (responsible for moving the distal tip of a single fiber across the proximal face of a rod-lens objective) with an optical scanner (responsible for rasterizing a laser beam across the proximal ends of fibers in an image guide). These designs still only illuminate one fiber at any given moment. While optical scanning substantially reduces image acquisition speed, these IG designs grossly underutilize image guide capabilities.

### SUMMARY

Particular embodiments of the present disclosure provide an image guide, such as a fiber optic bundle comprising a plurality of fiber optic strands. At least a portion of the plurality of fiber optic strands are sufficiently spaced apart, or have a suitably small diameter, such that each such strand acts as a confocal light aperture. In some embodiments, the spacing between fibers is increased by reducing the diameter of the fiber, such as by tapering, while maintaining the cross-sectional diameter of the image guide. In further embodiments, the spacing between fibers is increased without reducing the diameter of the fibers, but increasing the cross-sectional diameter of the image guide. In particular configurations, each light aperture both transmits and receives light. In specific examples, each confocal light aperture is at least substantially independent of other fiber optic strands, such as being sufficiently independent to allow for parallel confocal pixel acquisition for a plurality of fibers in the fiber optic bundle. In a specific example, the image guide allows for simultaneous acquisition of an entire confocal image.

In some examples the image guide is mechanically strengthened. In some example, the space between optic strands is filled by a rigid material, such as a potting compound. The potting compound is, in a specific example, an epoxy. The compound is opaque in some implementations. In specific examples a dye is added to the potting compound to render it opaque. The compound is, in certain examples, sufficiently opaque to at least substantially prevent out-of-focus light from entering the image guide.

In further configurations, the image guide is mechanically strengthened by surrounding at least a portion of the image guide with a rigid material, such as stainless steel. In a further example, the substantially rigid material is a rubber or plastic material. The image guide may be secured within the rigid material using an adhesive, in some implementations.

Embodiments of the present disclosure also provide methods for forming images guides having spaced-apart or reduced diameter optic strands. In one method, an image guide, such as a fiber optic bundle, having gradient index strands is etched to form fibers having a tapered portion. In a particular example, the strands comprise a Ge₂O doping profile and are etched using a hydrofluoric acid etching solution.

In further methods, suitable image guides are formed by heating at least a portion of the image guide until it obtains a plastic state. At least a portion of the image guide is then drawn to form tapers having a desired length, diameter, and taper profile. In particular examples, a drawing force, optionally symmetric, is applied to image guide ends on either side of a heated image guide section. After the desired tapers are produced, the image guide is cooled.

The resulting image guide can then be mechanically strengthened, such as by encasing the strands in a rigid compound or surrounding the image guide with a substantially rigid material. In more particular examples, before drawing out the strands, the image guide includes a leachable binder and the method includes leaching the leachable binder from at least a portion of the image guide such that individual fibers are mobilized.

After taper formation, the tapered section is cut radially, in certain methods. The distal ends of the tapers are then optionally ground to produce tapers having a desired aperture size. The tapers are then further optionally polished to increase the light transmitting properties of the taper ends. In particular methods, the aperture size is chosen to provide desired image properties, such as imaging area, axial slice resolution (thickness), or to image a particular slice of a sample a particular sample depth.

Such methods can allow suitably small diameter fibers to be formed such that each fiber acts as a light point source. Such methods can allow the fibers to be suitably spaced apart such that each fiber can act as a light point source. Each fiber can thus illuminate a particular portion of the sample, with each confocal aperture of a fiber blocking out-of-focus light, such as light not originating from that fiber. The plurality of fibers thus generate an array of confocal images. This array of confocal images can be combined to form an image of the sample. In implementations using an opaque material between fibers, the opaque material can aid in blocking out-of-focus light from entering the fibers.

Some embodiments of the present disclosure provide apparatus and systems including the disclosed image guide. For example, certain aspects of the present disclosure relate to endoscopes using disclosed image guides. Particular systems and apparatus include a light source, such as an arc lamp or a laser, in optical communication with the image guide, an objective in optical communication with light emitted from the distal strand ends, a detector, and a data processing station. In particular examples, the detector is a CCD imager. The system or apparatus can also include a path discriminator, such as a half-mirror or dichroic filter. In yet further examples, the system includes an image relay in optical communication with the path discriminator and the image guide.

In some embodiments, the present disclosure provides method of using the disclosed image guides, and systems and apparatus incorporating such bundles. In one method, an endoscope having an image guide of spaced-apart optic strands is inserted into a subject. A plurality of the strands are simultaneously illuminated. Light reflected from a sample within the subject is reflected back to the strands and is measured by a detector. The measured light is used to produce an image of the sample. In particular example, the image is of a sub-surface portion of the sample. In a more specific example, the sample is tissue suspected of being damaged or diseased, such as neoplastic tissue.

There are additional features and advantages of the subject matter described herein. They will become apparent as this specification proceeds.

In this regard, it is to be understood that this is a brief summary of varying aspects of the subject matter described herein. The various features described in this section and below for various embodiments may be used in combination or separately. Any particular embodiment need not provide all features noted above, nor solve all problems or address all issues in the prior art noted above.

### BRIEF DESCRIPTION OF THE DRAWINGS

Various embodiments are shown and described in connection with the following drawings in which:

FIG. 1 is a schematic illustration of a transmission mode confocal microscope including a light source (A), pinholes (B, F), a sample (D), focusing lenses (C, E) and a detector (G).

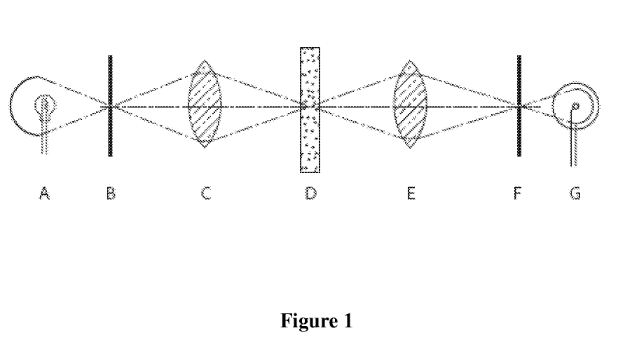

FIG. 2 is a schematic illustration of a fiber optic image bundle transmitting an image from an input end to an output end.

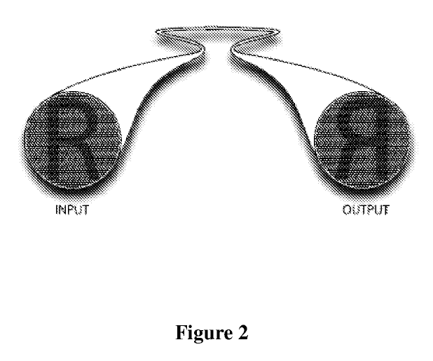

FIG. 3 is a schematic illustration of a portion of a disclosed confocal imaging apparatus.

FIG. 4 is a schematic illustration of drawing image guides with un-isolated fibers (upper image) and isolated fibers (lower image).

FIG. 5 is a schematic illustration of an image guide being drawn, the length of the hot zone, X-Y, is constant as points M-N are pulled apart.

FIG. 6 is a schematic diagram illustrating a method for etching, drawing, and re-enforcing at least a portion of an image guide.

FIG. 7 is a schematic illustration of a method for acid etching an image guide using a water-dam.

FIG. 8 is a schematic diagram of an optical test bench arrangement useable to measure particular disclosed embodiments of image guides.

FIG. 9 presents micro-images (negatives) captured before (top) and after (bottom) two separate IG drawings experiments. Scale bar (bottom right) equals 100 μm.

FIG. 10 is a graph of taper diameter versus location for a disclosed image guide. Taper location represents amount of material removed from the distal face of the image guide by grinding.

FIG. 11 is a graph of a sample PSF curve acquired by translating mirror through focal plane. Intensity has been scaled for clarity.

FIG. 12A and 12 B are graphs of normalized PSF data from the image guides, left and right, respectively, shown in FIG. 9.

FIG. 13 is a graph of section thickness versus aperture diameter for the image guides of FIG. 9. Open circles represent previously reported data.

FIG. 14 are images (negatives) of the distal ends of two disclosed image guides.

FIG. 15 is a graph of a sample PSF curve between the tapered and untapered assemblies of FIG. 14.

FIG. 16A and 16B are illustrations of single fiber taper assembly profiles constructed from drawing experiments of the, left and right, respectively, image guides of FIG. 14. Dimensions are in mm.

FIG. 17 presents a series of images (negatives) from the assembly of FIG. 16B captured after each grind/polish cycle.

FIGS. 18A and 18B present PSF curves for all apertures created in the assemblies of FIGS. 16A and 16B.

FIG. 19A and 19B present normalized PSF curves for all apertures created in the assemblies of FIGS. 16A and 16B. Arrows indicate half-maximum.

FIG. 20 presents a graph of section thickness versus aperture size for the assemblies of FIGS. 16A and 16B.

FIG. 21 is a schematic illustration of a conscope Zemax model where 1 represents the entrance pupil, 2 the modified image guide, 3 the objective, 4 the front surface mirror, 5 a return path objective, 6 a return path modified image guide, 7 a return path exit stop, and 8 an image plane.

FIG. 22 is a Zemax model of the proximal face of an image guide (upper image) and a photo-micrograph of an actual image guide.

FIG. 23 is a Zemax model of the distal face of an image guide where apertures are represented by smaller circles in each fiber center. Apertures are set to 25 μm.

FIG. 24 is a graph of efficiencies from five ray volume trials. Trials were preformed for 15,000; 25,000; 50,000; 100,000; and 250,000 rays. Error bars indicate±one standard deviation, N=29. Parameters for ray experiments were: (tr)=0.55, (sl)=5 μm, (tl)=3.329 mm, (sp)=100, (σ)=2.

FIG. 25 is a graph comparing PSF data from 15,000 ray curve (dashed) versus 200,000 ray curve (solid). Model run time for 15,000 was 2 hours. Model run time for 200,000 was 16 hours.

FIG. 26 is a graph of efficiency versus mirror position of IG to objective spacing Zemax experiments. PSF curves from spacing set to 1, 5, 10, 15, 20, and 25 mm. Peak focal plane efficiency is indicated by arrow and value. Variable values were: (tr)=0.55, (sl)=1 μm, (tl)=3.329 mm, (sp)=0, (σ)=0. Shifted upwards for clarity are the 5, 10, 15, and 22 mm curves. Z=0 set to objective face for profile comparisons.

FIG. 27 is a graph of efficiency versus mirror position showing the effect of increasing the percent of rays scattered at the mirror surface. Scattering percentages of 0, 25, 50, 75, and 100% were investigated. Variables were set to (tr)=0.40, (sl)=5 μm, (tl)=3.329 mm, (σ)=0.25.

FIG. 28 is a graph of efficiency versus mirror position showing the effect of increasing σ for scattering at the mirror surface. Sigma levels plotted are 0.10, 0.20, 0.25, 0.30, 0.40, and 0.50. Variables were set to (tr)=0.40, (sl)=5 μm, (tl)=3.329 mm, (sp)=100.

FIG. 29 presents graphs PSF curves from conscope model taper length/angle experiments. Un-normalized data (top) from lengths of 0.5, 1.0, 3.329, 5.0, and 10.0 mm. Normalized data (bottom) from the same trials highlight curves from 0.5 and 1.0 mm taper lengths. Bottom data normalized in the vertical axis. Variables were set to (tr)=0.55, (sl)=5 μm, (sp)=100, (σ)=0.25.

FIG. 30 presents normalized PSF profile data resulting from blocking successive out rings. Arrows indicated number of rings un-blocked relative to original 91 element hexagonal bundle. Data normalized in the vertical axis. Variables were set to (tr)=0.55, (sl)=5 μm, (tl)=3.329 mm, (sp)=100, (σ)=0.25.

FIG. 31 presents normalized PSF curves from six largest taper ratio trials. Normalization is in the vertical axis. Variables were set to (sl)=5 μm, (tl)=3.329 mm, (sp)=100, (σ)=0.25.

FIG. 32 presents a graph of normalized efficiency versus mirror position from all eight taper ratios (distal side of focal plane only). Arrow indicates half-height point for determining section thickness.

FIG. 33 is a graph comparing section thicknesses predicted by the conscope model (triangles) and those measured from optic bench assemblies (squares and circles).

FIG. 34 is a graph of PSF profile data acquired from optical bench measurements with a taper ratio of 0.30. Data was normalized in the vertical axis. Focal plane is indicated by an axial mirror position of zero.

FIG. 35 is a graph of PSF profiles acquired at the optic bench during aperture removal experiments. Non-focal plane signal (<˜−0.05) reduces in magnitude as apertures are removed.

FIG. 36 is a graph of PSF profiles for a TACE taper ratio of 0.25. Data was normalized in the vertical axis.

### DETAILED DESCRIPTION

Unless otherwise explained, all technical and scientific terms used herein have the same meaning as commonly understood by one of ordinary skill in the art to which this disclosure belongs. In case of conflict, the present specification, including explanations of terms, will control. The singular terms “a,” “an,” and “the” include plural referents unless context clearly indicates otherwise. Similarly, the word “or” is intended to include “and” unless the context clearly indicates otherwise. The term “comprising” means “including;” hence, “comprising A or B” means including A or B, as well as A and B together. Although methods and materials similar or equivalent to those described herein can be used in the practice or testing of the present disclosure, suitable methods and materials are described herein. The disclosed materials, methods, and examples are illustrative only and not intended to be limiting.

Disclosed embodiments of confocal endoscopes include a modified fiber-optic imaging bundle, or image guide (IG). The modified IG includes a plurality of spaced apart fibers. A coherent fiber arrangement with, typically, many thousands of optical fibers within the bundle helps provide faithful transmission of an image imposed on one end of the IG, albeit pixilated, to the other end.

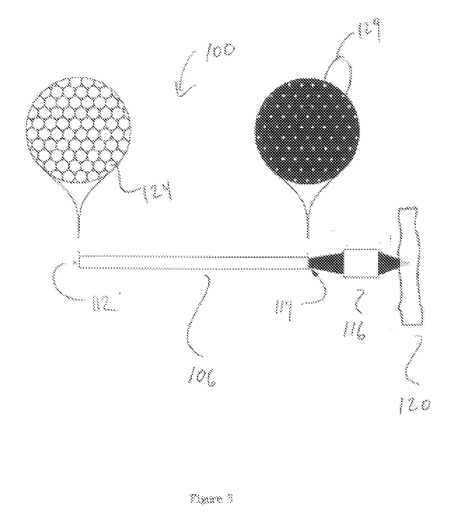

FIG. 3 presents an embodiment of a portion of an apparatus 100 including a disclosed image guide 106. The image guide 106 includes a plurality of strands, such as individual fiber optic strands. The image guide 106 can include any desired number of strands, depending on the application of the apparatus 100.

The image guide 106 includes a proximal face 112 and a distal face 114. The distal face 114 is in optical communication with an objective 116, which transmits light to, and receives reflected light from, a sample 120. In the embodiment of FIG. 3, the individual fiber strands 124 are packed closely together at the proximal face 112.

The distal end 114 of the image guide 106 provides a plurality of spaced-apart, or small diameter, fibers 124. The space between fibers, or fiber diameter, is sufficient to allow parallel image acquisition from at least a portion of the fibers 124. As discussed further below, such a configuration may help reject out-of-focus light and minimize crosstalk between fibers. In addition, such a configuration can allow each fiber to act as point light source, illuminating a particular portion of a sample and collecting in-focus light. Images from the plurality of fibers can be combined to produce an image of the sample. Such endoscopes may be formed by modifying a pre-existing image guide, created by suitable manufacturing techniques, or obtained from commercial sources.

In some examples, suitable apertures are produced by reducing the diameter of the fibers 124, such as by tapering, while maintaining the cross-sectional diameter of the image guide 106. In further examples, suitable apertures are produced by increasing the spacing between fibers 124, increasing the cross-sectional diameter of the image guide 106.

In a particular implementation, the present disclosure provides a tapered-array confocal endoscope (TACE). In the TACE system, each fiber is tapered as it approaches its distal tip. Etching and thermal drawing are two techniques that can be used to form such tapers; including forming tapers from commercially available image guides. In other implementations, tapers can be etched into fiber with a GeO2 doping profile, i.e. gradient index (GRIN) optical fiber. For example, an etchant composed of hydrofluoric acid (HF), ammonium fluoride (NH4F), and water (H2O) capably etches tapers (data not shown) using GRIN image guide (IGN-05/10, Sumitomo Electric Industries, Torrance, Calif.). Etching techniques are described further in Muramatsu, H. and Chiba, N., “Frictional imaging in a scanning near-field optical/atomic-force microscope by a thin step etched optical fiber probe”, October 1997, Appl. Phys. Lett., Vol. 71, pp. 2061-2063 9 and Marchman, H. M., Griffith, J. E., Filas, R. W., “Fabrication of optical fiber probes for nanometer-scale dimensional metrology”, August 1994, Rev. Sci. Instrum., Vol. 65 (8), pp. 2538-2541.

A desired method of taper formation can be selected based on various considerations, including the application of the fiber, the nature of the fiber, and cost. However, the various taper forming techniques can produce tapers having different qualities. For example, drawing typically leaves the fibers' original index of refraction profile intact, whereas etching can alter the refraction profile index. Also, light traveling down the length of a fiber with a drawn taper typically experiences a very gentle sidewall transition as it enters the taper. In contrast, etching often leaves an abrupt shoulder where the taper meets unmodified fiber. Smooth transitions in fiber geometry can be important in maintaining transmission efficiency.

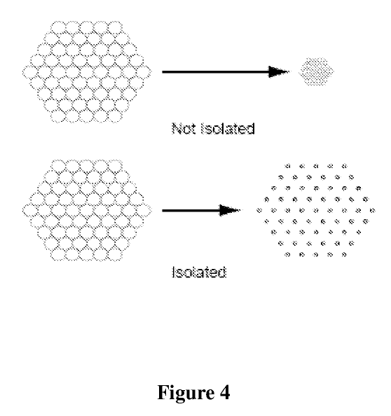

The steps of thermal fiber tapering including heating the fiber, drawing out the fiber, and cooling down the drawn fiber. The first phase, application of heat, transforms a localized region of exposed fiber to a plastic state. The second, applying force in opposite directions down the long axis of a fiber, narrows the fiber until a biconical taper forms. The applied force is typically symmetrical. Cooling of the fiber results in the fiber retaining its newly imposed shape. When applied to a typical, unprepared image guide, this process forms a single overall biconical taper rather than the many individual tapers needed. Drawing contracts the outer diameter of the unprepared bundle as well as the center-to-center spacing of individual fibers (FIG. 4, top panel), creating no additional ‘dead space’ between fibers.

An array of pinholes with maintained center-to-center spacing may be constructed by forming each individual fiber form into its own taper, independent of the fibers around it. To facilitate independent contraction, an image guide was chosen that was manufactured with a ‘leachable’ binder (Schott Fiber Optics Southbridge, Mass.). Image guide typically consists of fibers encased in a permanent binding matrix that adds rigidity. In contrast, leachable guide is made so the binding matrix can be removed and therefore mobilize individual fibers.

When the drawing technique is used, a length of IG can be obtained, such as being cut from a longer length of IG using a suitable cutting device, such as a slow-speed diamond saw. The IG may then be cleaned, heated, and drawn. Any suitable heating device may be used, such as jet of flammable gas or a heating element, such a coil or length of nichrome wire.

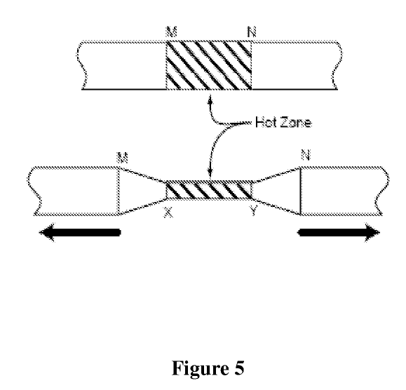

A number of variables can affect the profile of tapers formed during the drawing process: environment temperature, glass properties, hot zone length, drawing force, drawing speed and extension distance. Birks and Li showed though, that only two parameters need to be addressed to form desired any taper shape—length of the hot zone and extension distance.11 The ‘hot zone’ refers to the region of fiber that softens enough to begin collapsing (FIG. 5). Material outside the hot zone (M-X and Y-N in FIG. 5) by definition has cooled and therefore is no longer malleable. Consideration of complex fluid mechanics is not required as long as the fiber remains cylindrical and the temperature of the hot zone cross-section is uniform (i.e. the hot zone has a consistent viscosity). While the ‘hot zone’ taper control concept was developed in a single fiber model, it has been applied in the present disclosure to IG, being careful to add heat to the taper area very slowly—such as, for example, no more than 10° C. per minute. Gradual temperature adjustments help maintain consistent fiber viscosities across the bundle.

After drawing, the space between fibers is typically filled with a rigid material in order to provide mechanical strength to the taper array. Such mechanical strength can help the assembly remain intact during cutting, grinding, and polishing steps. In some implementations the rigid material is plastic material that subsequently hardens, such as an epoxy. In particular examples the material is opaque, or an opacifing agent (darkening agent) added thereto. Rendering the filler material opaque can help prevent out-of-focus light from entering the fibers from anywhere but the apertures. The resulting fiber assembly can be further mechanically supported, such as by placing the assembly inside a rigid material (or coating the assembly with a rigid material). In certain examples, the assembly is placed inside a steel tube, such as a stainless steel tube.

The drawn section of the assembly is typically cut to provide two assemblies. The distal end of each assembly can then be treated to provide a desired surface. For example, the distal ends can be ground to provide a desired aperture size. The distal ends can then be polished to provide a desired surface for transmitting or receiving light.

Appropriate fiber characteristics, such as fiber length, aperture size, space between fibers, and number of fibers in the image guide, can be empirically determined for a particular application of the image guide. Similarly, mechanical properties of the image guide can be tailored for a particular application, such as the degree of mechanical support and flexibility of the image guide.

Possible TACE applications are as varied as those of the endoscope itself. The ability to acquire full-frame, confocal images at a rate limited only by the image detector, in a minimally invasive environment, may open new doors for clinical diagnostics. Any tissue accessible to an endoscope would be available for confocal examination. In vivo confocal tissue pathology could ultimately provide entirely new insights into disease processes. In its final configuration the TACE could have all of the following desirable characteristics: lightweight, inexpensive, disposable, selectable resolution, working distance and lengths.

### EXAMPLE 1

Fabrication of a Confocal Fiber Array

An array of pinholes with maintained center-to-center spacing can be generated when each individual fiber forms its own taper, independent of the fibers around it. To facilitate independent contraction, an image guide manufactured with a ‘leachable’ binder (Schott Fiber Optics Southbridge, Mass.) was chosen. Image guide typically consists of fibers encased in a permanent binding matrix that adds rigidity. In contrast, leachable guide is made so the binding matrix can be removed and therefore mobilize individual fibers. While image guide bundles typically consist of 10,000 fibers or more, a special 91 fiber ‘precursor’ bundle was used to aid in process visualization.

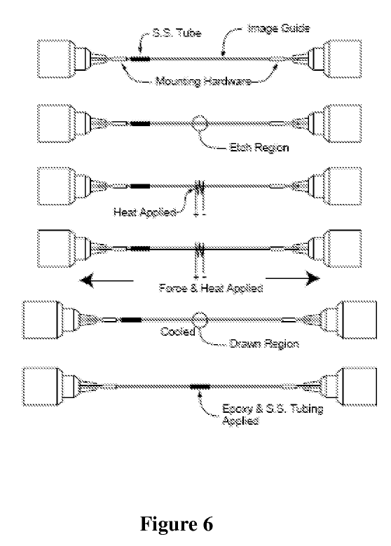

To begin the tapered array confocal endoscope (TACE) array formation process, a piece of image guide (IG) was cut with a slow-speed diamond saw (Isomet, Buehler Ltd., Lake Bluff, Ill.) The IG was then cleaned with alcohol and sonicated in water for 30 seconds to remove any foreign matter. Next, a 10 mm length of stainless steel tubing (304H15TW, MicroGroup, Medway, Mass.) was slid onto the IG before 1/16″ diameter×25 mm shrink wrap was heated onto IG ends. Shrink wrap extensions ensured that no forces, except precisely along the axis, were applied to the IG while in the fixture. The guide was then mounted in the custom etching/drawing fixture (FIG. 6). A constant 10 lb force was applied down the long axis of the IG for the remainder of the etching/drawing/re-strengthening processes.

Fixture elements as well as steps involved in the drawing process are highlighted in FIG. 6. The fixture performs several functions. The two mounting jaws (22BA ⅜, Jacobs, Clemson, S.C.) move apart staying precisely aligned while applying IG tension. In addition, a heating element is incorporated in the fixture in a manner that allows translation into and out of the taper zone without contacting the IG. Lastly, a 0.001 in. resolution micrometer (L. S. Starrett Co., Athol, Mass.) indicates the amount of jaw separation.

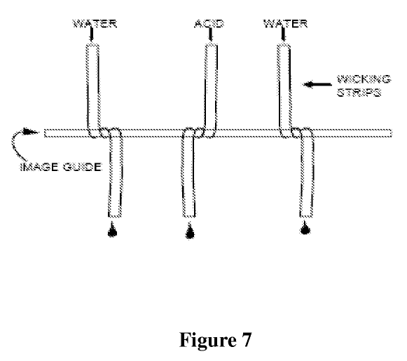

To mechanically isolate IG fibers, the silica-based binding matrix was removed by etching with a 5% solution of hydrochloric acid. The goal was to remove the matrix along a small distance (˜20 mm) located in the middle of the bundle. To achieve localized etching, a water-dam drip method was developed (FIG. 7). Three 10 mm×100 mm strips of dialysis membrane (i.e. wicking strips) were wrapped once around the image guide—each terminating in a waste catch basin. The central strip was fed with a tube delivering etchant and outer strips were fed with de-ionized water. This arrangement ensured that the acid was significantly diluted before it had a chance to travel outside the etching zone. The length of the etched area was finely adjustable using this method.

Drip rate was controlled by a flow regulator on each feed line and all were set to approximately 60 cc/hour. To guarantee that the binding matrix was completely removed in the tapering zone, the etching process was performed for a minimum of twelve hours at room temperature. Once etching was completed, strips were removed and the guide was washed with 100 ml each of de-ionized water and alcohol to entirely remove etch residue.

The fiber array was then drawn, beginning by first moving the heating coil into position encircling the taper zone (FIG. 6, step 3). The heating element consisted of a 0.8 mm diameter nichrome wire formed into a four-turn coil with a loop diameter of approx. 7 mm. An adjustable, constant voltage DC source delivered energy for the element. Drawing environment temperature feedback was supplied by a miniature thermocouple sensor (J type, IRCO-010, Omega, Stamford, Conn.) placed in contact with the outer surface of the coil.

The 10 lb axial tension provided drawing force once the fiber reached a plastic state. After the heating element was adjusted (in all three axis) to make certain the taper area was centered in the coils, current was slowly applied until the tapers began to form. Addition of current was stopped at initiation of tapering and the guide was allowed to extend a pre-determined amount. Taper extension was stopped by removing the heat and allowing the fibers to cool in ambient air.

Binding matrix removal and tapering can leave the fibers very fragile. The TACE assembly was finished using a slow-speed saw cutting operation (to separate taper halves) and a grinding/polishing regimen. Without renewed inter-fiber support, these mechanically aggressive processes can shatter the tapers. Therefore, an epoxy was designed with the following characteristics: highly opaque, very low viscosity, negligible shrinkage, and high hardness (EP30LV, MasterBond, Hackensack, N.J.). The epoxy was customized by the manufacturer by adding a darkening agent to product EP30LV. Opacity helps prevent out-of-focus light returning from the sample from inadvertently entering the tapers anywhere but the distal aperture. Low viscosity allows the epoxy to wick easily into minute spaces between fibers. Low shrinkage helps prevent fibers from cracking during the curing process. Finally, high hardness can aid in subsequent grinding and polishing steps.

After the image guide was allowed to cool, spaces around the tapers were carefully filled with the custom epoxy. Next, the stainless steel tubing pre-loaded onto the guide was moved over the uncured epoxy so it encased the entire taper area. As directed by the manufacturer, the epoxy was allowed to cure at room temperature for a minimum of 8 hours; final curing was done in an oven at 212° F. for 2 hours.

To expose the apertures of the confocal array, the modified image guide was transected precisely at the waist of the tapers using the slow-speed diamond saw. This cut created two lengths of image guide each with a tapered-array located at the distal face (as shown in FIG. 3). Although the stainless steel tube and epoxy supported the tapers at the distal end, the proximal end was further strengthened by encapsulating the full length of each assembly in epoxy inside an additional ˜65 mm long stainless steel sleeve (316H13TW, MicroGroup, Medway, Mass.).

Grinding and polishing was the final step in preparing the assemblies for evaluation. The rotating sample platen of a polisher (Ecomet 4/Automet 3, Buehler Ltd., Lake Bluff, Ill.) was modified to hold each assembly such that it was normal to the abrasive plane. The following polishing regimen was applied to each assembly face: 2 minutes −30 μm grit followed by 4 minutes each on 12, 9, 3, and 1 μm grit sheets. All cycles were performed with a constant 4 lbs of downward pressure and the abrasive plate was rotated at 100 rpm. After each cycle the assembly was rinsed in water, blown free of grindings using compressed nitrogen, wiped with alcohol soaked cotton, and visually inspected to verify polishing performance.

Evaluation of the Fiber Assembly

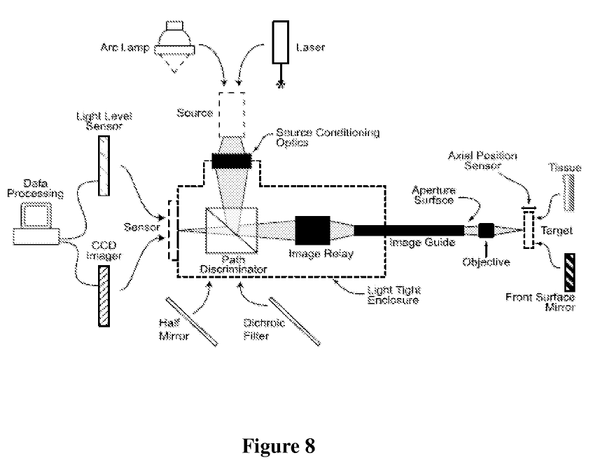

FIG. 8 shows the optical bench arrangement used for evaluating assembly performance. The optic train consisted of a light source, source conditioning optics, beamsplitter, image relay, modified image guide, objective, target and a sensor. A 100 mW 532 nm pumped diode laser (C-1001, CrystaLaser, Reno Nev.) provided illumination for all experiments. Neutral density filters and a beam expander were used to adjust intensity and diameter of the beam respectively.

Path splitting was performed using a 50% half-mirror (NT47-023, Edmund Optics, Barrington, N.J.). Reflected light from the beam splitter was imaged by a relay lens such that it filled the polished proximal end of a modified image guide under examination. After traversing the image guide and exiting the pinhole array, light entered the back of a microscope objective (Jena Apochromat 40× 0.95 NA). The objective was axially and radially adjustable for system alignment. Light exiting the objective encountered a front surface mirror (NT45-605, Edmund Optics, Barrington, N.J.) which was attached to a gimbal style mount (07 MGS 503, Melles Griot, Rochester, N.Y.). The axial position of the mirror was recorded using a linear variable differential transducer (125DCEC, Lucas, Hampton, Va.) whose output was captured by computerized data acquisition. To reduce vibration noise during mirror movement, the mirror mount was translated with a motorized translation system (860MC3, Newport, Irvine Calif.).

After striking the mirror and returning through the objective, light re-entered the array and traveled back through the elements until striking the beamsplitter. Light allowed to pass through the beamsplitter encountered a PerkinElmer (Fremont, Calif.) n-type silicon PIN photodetector (PD) (Part No. C30810) that was integrated into a custom amplification and metering circuit designed by Agtron, Inc (Reno, Nev.). The amplifier was custom designed to be capable of measuring very small changes in a large amount of radiant flux, ignoring steady state light levels inside the enclosure.

Signal conditioning in the circuit is achieved in four stages. The first stage is a current-to-voltage converter driven by the photodetector. The next two stages consist of a fixed gain stage followed by an op-amp whose reference voltage and gain are finely adjustable. The last stage has a fixed gain and presents a signal ranging from −12 to +12 volts. Captured data from the sensor were displayed and recorded as a simple magnitude or plotted against axial target position using a custom LabView based program (National Instruments, Austin Tex.).

Preparation of the optic train for TACE evaluation began by installing a ½″, three-chip color camera in the sensor location (732, Stryker, Kalamazoo, Mich.). The camera sensor was placed precisely at the back focal plane of the optic bench. After being turned on, the laser was allowed to stabilize for at least fifteen minutes. Once placed in the optic path, the image guide was adjusted axially until its proximal end was in focus at the camera. The camera was then replaced with the PD sensor being careful to locate it once again at the back focal plane. The objective was then placed so that i) its proximal optical surface was located ˜10 mm from the distal end of the image guide and ii) its axis was aligned with that of the system. Alignment of the target mirror helped ensure that each pinhole in the array focused back upon itself. As the maximal amount of light returns back through the TACE array when the mirror is normal and located at the confocal position, the mirror was adjusted in all five axis (x, y, z, rotation about x, rotation about y) until maximum intensity was detected at the sensor.

Once the system was aligned, an axial point spread function (PSF) curve could be acquired. Although the PSF generally describes the response of an optical system to single, infinitely small point of light, the same analysis is used here to describe the response generated by an entire array of pinholes. To prepare the system for PSF acquisition, neutral density filters (located in the source conditioning optics) and the sensor amplifiers were adjusted so that the full intensity range of the PSF profile could be recorded. To acquire a profile, the mirror was initially placed in the most proximal position without touching the objective. Data acquisition was initiated and the mirror was slowly moved distally using the motorized translation stage. Data were acquired at a rate that provided for at least one intensity/position data pair every ten-thousandth of an inch. Once the mirror reached the distal limit, motion was stopped and acquisition turned off.

After PSF recording, TACE assemblies were removed from the optic train and placed under a Nikon Eclipse E400 microscope and CCD camera (Kodak DC 120) for distal face measurements. Measurements were calibrated by acquiring an image of a 0.01 mm microscope micrometer located in the focal plane. Configuration of the microscope and camera were consistent throughout all measurements. After image capture was complete, face and micrometer images were combined digitally so apertures and spacings could be measured.

Results and Discussion

Array Structure

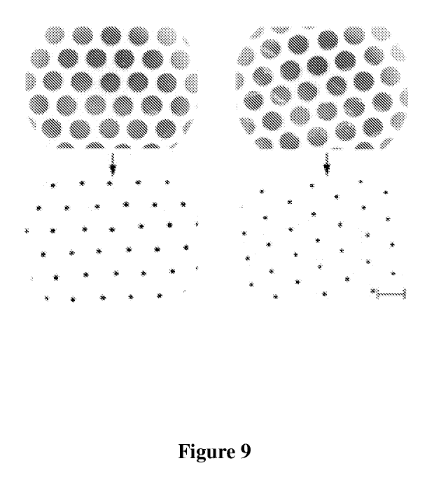

A single TACE experiment began with formation of the tapered-array and concluded with distal face measurements. After each experiment negative micro-photographs were captured of the distal and proximal image guide fiber patterns. Images acquired from two separate experiments are shown in FIG. 9 where unmodified image guides are shown across the top and the aperture arrays resulting from the drawing experiments are at bottom. ‘Dead’ space between apertures in the un-tapered guide is composed of fiber cladding and binding matrix. Conversely, dead space in the tapered-array is filled with opaque epoxy. Because these pictures were used to measure aperture diameters and center-to-center spacings of the fibers, the microscope magnification was chosen carefully (˜125×) to provide a balance between number of fibers imaged versus edge sharpness. As a result, the field of view encompassed approximately 35 fibers with the number varying depending on rotation.

Measurements taken from images in FIG. 9 are summarized in Table 1. Fibers in the unmodified image guide began with a constant core dimension of 100 μm. During the drawing step for each experiment (FIG. 6, step 4), the image guide was allowed to lengthen approximately 2 mm with the fiber becoming plastic near 550° C. This combination of drawing environment variables (hot zone length, extension distance) produced a reduction in aperture size of approximately 5:1 which corresponds to a new center-to-center spacing vs. aperture size ratio of ˜7:1. This ratio is in the range suggested by Fewer who showed that it provides an acceptable level of contrast in the confocal image.

Fewer, D. T., Hewlett, S. J., McCabe, E. M., and Hagerty, J. “Direct-view microscopy: experimental investigation of the dependence of the optical sectioning characteristics on pinhole-array configuration,” 1997, J. Microsc (Oxford), Vol. 187, pp. 54-61. The two experiments shown in FIG. 9 show resultant aperture sizes of 19 μm and 22 μm. Each experiment produced a high degree of aperture size consistency. To maximize light rejection area between apertures, the original center-to-center spacing of the hexagonal pattern typically needs to be preserved. Data in Table 1 demonstrate that the aperture spacing was successfully maintained at approximately 138 μm.

TABLE 1
Fiber dimensions from two typical drawing experiments.

| Aperture | Aperture | Aperture | Aperture |
|---|---|---|---|
| Size (i) | Size (f) | Spacing (i) | Spacing (f) |
| 100 μm | 19 ± 0.80 μm (N = 30) | 138 ± 3.07 μm (N = 80) | 138 ± 6.27 μm (N = 85) |
| 100 μm | 22 ± 0.65 μm (N = 24) | 137 ± 4.13 μm (N = 87) | 138 ± 5.62 μm (N = 71) |

Shown are initial (i) and final (f) aperture sizes and initial and final aperture center-to-center spacings.
Measurements with tolerances are shown ± one standard deviation.

Taper Profile

A summary of taper profiling data reported elsewhere is included here to illustrate the results of the tapering process. R. Pillers, N. Publicover, “Novel design for a confocal endoscope,” in Proc. SPIE Vol. 6082 Endoscopic Microscopy, Guillermo J. Tearney M.D., Thomas D. Wang; Eds.; (SPIE, Bellingham Wash. 2005), pp. 9-14. Measurement of drawn taper profile was achieved by applying a cyclic process of aperture measurement and distal face grinding/polishing. Aperture diameters were microscopically measured using the same process as described above in ‘Evaluation.’ Before being returned to the polisher, aperture dimensions were measured. This cycle was repeated until tapers were no longer evident and the fibers had returned to their original pre-tapered dimension.

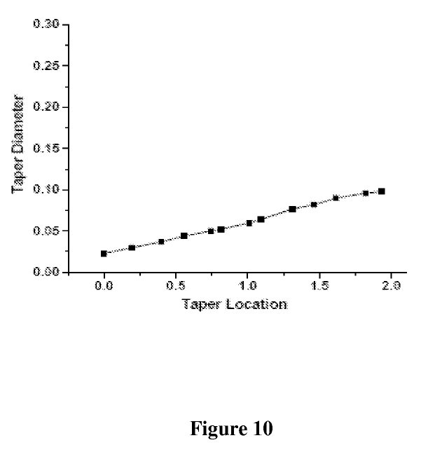

Taper profile data acquired from a measurement/polish cycle is shown in FIG. 10. Horizontal axes represent the location along the length of the taper array where apertures were measured (i.e. how much material was removed from the distal face). These data represent an array with initial aperture sizes of 22 μm. Thirteen grinding/polishing cycles resulted in aperture diameters returning to near the original of 100 μm. Each cycle removed approximately 150 μm of material from the distal face. Tapers created in this particular example were very near linear and had a taper half-angle of 1.11°.

Formation of apertures with a pre-determined diameter is a two step process. The first step is to draw the tapers down to a waist diameter smaller than the desired diameter. Since this step creates apertures smaller than necessary, they may be adjusted back up to the pre-determined diameter by grinding/polishing. Data presented in FIG. 10 show that by adjusting the polishing regimen, any diameter along the length of the tapers can be precisely selected.

Sectioning Thickness

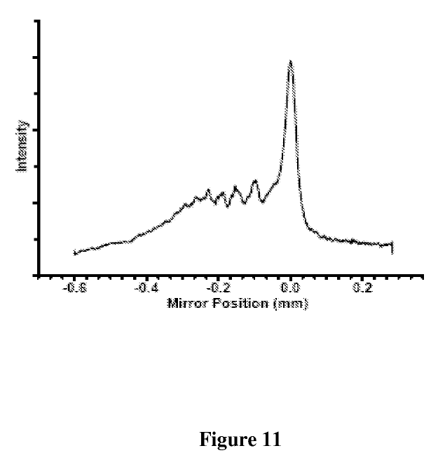

Optical section thickness is generally defined as the distance between the full-width half-maximum (FWHM) points of the axial PSF. A typical TACE PSF curve is shown in FIG. 11. In this example, the curve acquisition began with the mirror as close to the objective as possible without making contact (approx. −0.60 mm). Axial measurements were then calibrated so that a reading of zero corresponded to the focal plane. The mirror was translated distally until either changes in signal response ended or until the translation limit was reached (approx. 0.283 mm).

The extraneous peaks to the left of the focal plane may be due to spherical aberration. Spherical aberration causes non-paraxial light to be focused away from the paraxial focal point. The degree of error typically increases with lens diameter. Therefore, to accurately compare axial profiles between experiments section thickness was measured using positive mirror positions only. The half-height, half-width measurement from the positive side of PSF curves were obtained and doubled to represent FWHM values. For comparison, each of the PSF profiles was normalized in the vertical axis to compensate for gain variations at the intensity sensor amplifier.

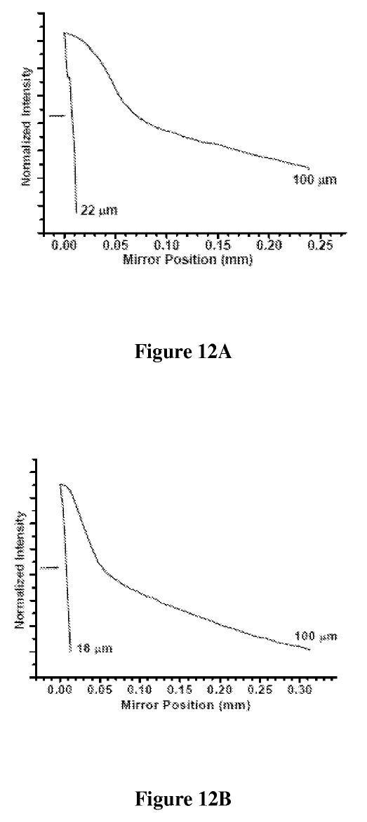

FIGS. 12A and 12B show PSF data acquired from experiments whose face images are shown in FIG. 9. The rightmost curve in each graph represents the axial response with original (unmodified) aperture arrays. Interestingly, these un-tapered IG response curves reveal that un-modified image guide possesses some degree of out-of-focus light rejection. This inherent ‘confocality’ may be created by the light acceptance cone of each fiber.

NA of a fiber in air is calculated:

$$N . A . = \sqrt{{n}_{1}^{2} + {n}_{2}^{2}} \qquad ( 1 )$$

where n1 represents the index of refraction of the fiber core and n2 represents that of the cladding. The half angle of the acceptance cone is then:

Half Angle=sin⁻¹(N.A.) (2)

Typical acceptance cone half angles for image guide are from 30° to 40°. In other words, any light striking the face of the fiber at an angle greater than this will not be contained in the core of the fiber and thereby lost. Using FIG. 3 as a reference, inherent image guide confocality can be explained.

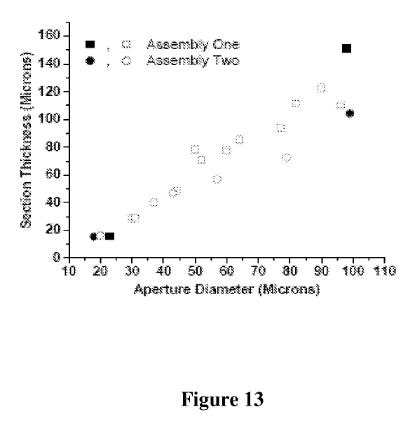

Optical properties of the objective dictate that light rays originating from planes longer, or to the right, of the focal plane strike the distal face of the IG at an angle greater than those from the focal plane itself. Therefore, rays originating from planes farther and farther to the right of the focal plane eventually exceed the acceptance cone. Although the exact cause of inherent confocality is not yet understood, the inherent confocality can be seen in that unmodified image guides had FWHM measurements under 200 μm. The arrows in FIGS. 12A and 12B are located at the half-height point indicating section half-thickness. Section thickness reduction data from FIGS. 12A and 12B are listed in Table 2. Each of these thicknesses are plotted in FIG. 13.

It can be seen in FIGS. 12A, 12B and 13 that experimental agreement is better for the small apertures in tapered-arrays than large aperture arrays of the original. This may be due to difficulties in mirror alignment at larger apertures. Intermediate section thicknesses reported elsewhere are also show in FIG. 13 to illustrate nearly linear transition between modified and unmodified arrays. Petran, M., Hadravsky, M., Egger, D., Galambos, R., “Tandem Scanning reflected-light microscope,” 1968, J. Opt. Sci. Am., Vol. 58, pp. 661-664.

TABLE 2
Section thickness reductions from two drawing experiments.

| Aperture Size | Aperture Size | Section Thickness | Section |
|---|---|---|---|
| (i) | (f) | (i) | Thickness (f) |
| 100 | 19 | 104 | 16 |
| 100 | 22 | 151 | 16 |

Shown are initial (i) and final (f) aperture sizes and initial and final section thicknesses.
All measurements are in microns.

Adjusting the mirror to its axis normal position was straightforward with the tapered-arrays as the peak intensity reading dropped rapidly with the slightest movement away from normalcy. In contrast, during unmodified assembly examinations large mirror deviations away from normal generated very little intensity change. In other words, precise mirror alignment was difficult when unmodified assemblies were examined. With the mirror not normal to the optic axis, only a portion of the array could be in focus (confocal) at once. In that condition, many mirror locations present the same amount of in-focus and out-of-focus light to the array resulting in PSF profiles being spread out along the z-axis. Data in FIG. 13, in addition to that reported elsewhere, indicates an apparent one-to-one relationship between aperture diameter and section thickness. R. Pillers, N. Publicover, “Novel design for a confocal endoscope,” in Proc. SPIE Vol. 6082 Endoscopic Microscopy, Guillermo J. Tearney M.D., Thomas D. Wang; Eds.; (SPIE,

Bellingham Wash. 2005), pp. 9-14.

### EXAMPLE 2

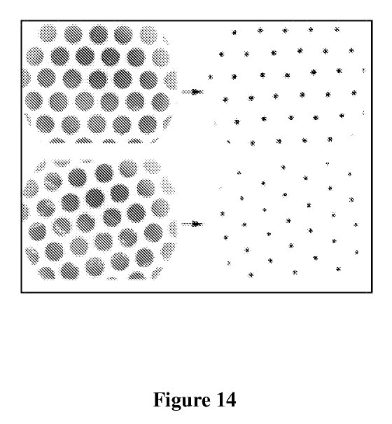

An image guide (IG) was prepared according the general method of Example 1. FIG. 14 shows two tapered assemblies before and after drawing. It can be seen in these distal face micrographs that significant light ‘rejection’ space was created between the fibers while the center-to-center spacing did not change.

The IG chosen for these experiments was a 91 element ‘pre-cursor’ bundle which the manufacturer combines with identical bundles to generate the multi-thousand element bundles normally used to manufacture endoscopes. The pre-cursor IG allowed the use of optical microscopes (40-100×) for process verification compared to off the shelf IG (8,000-30,000 elements) that typically requires the use of a scanning electron microscope at every validation step. The IG fibers illustrated in FIG. 14 had a diameter of 100μ before tapering and were drawn down to 18μ and 23μ.

The success of the tapering process was evaluated based on three points: i) consistency of final aperture size across the array, ii) retention of center-to-center spacing, and iii) complete restrengthening evidenced by unbroken fibers after polishing. After polishing, each assembly was mounted into the optic bench for axial point spread function (PSF) measurements using an optical bench arrangement as described in Example 1.

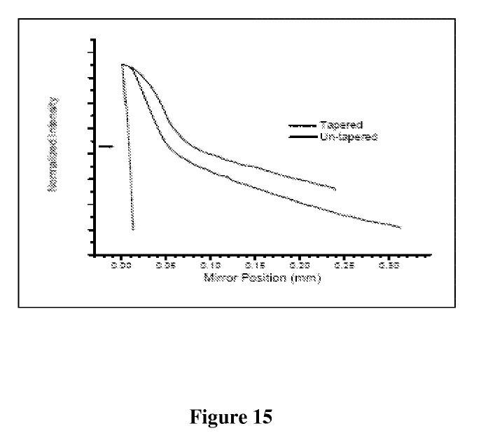

The PSF of any confocal microscope defines the light rejecting properties and therefore the optical sectioning capabilities of a system. PSF's from each of the assemblies before and after tapering are shown in FIG. 15. Section thicknesses from this graph are measured as double the mirror position at the half-maximum point. These two IGs show a thickness reduction from an average of 136μ for the un-tapered assemblies to 16μ for the tapered. A mirror position of zero represents placement at the ideal focal plane of the system.

Aperture Adjustment and Measurement Process

Aperture size is initially influenced primarily by three process functions: i) how long the drawing process was allowed to proceed, ii) where on the biconical taper the cut was made to separate the halves, and iii) the polishing recipe used on the distal IG face. A desired aperture thickness can be obtained by first creating apertures as smaller than desired, and then slowly remove material from the distal face to adjust diameter.

Material was removed from the distal face through a grinding—polishing process. The rotating sample platen of a polisher (Buehler, Ltd) was modified to hold each assembly such that it was normal to the abrasive plane. The following polishing protocol was then applied: 2 minutes on 30 μm size grit followed by 4 minutes each on 12-, 9-, 3-, 1- and 0.3-μm lapping sheets. The polisher was programmed to hold a constant 4 pounds of pressure and 100 rpm for all cycles. After each grit, the assembly was rinsed in water, blown free of grindings (using compressed nitrogen), wiped with alcohol soaked cotton, and visually inspected to verify polishing performance. After completion of the recipe, the assembly was mounted in the bench and an axial PSF was acquired.

Before being returned to the polisher, an image of the distal face was captured to facilitate aperture measurement. This cycle, polish—PSF—image, was repeated until tapers were no longer evident and the apertures had returned to their original dimension.

Results and Discussion

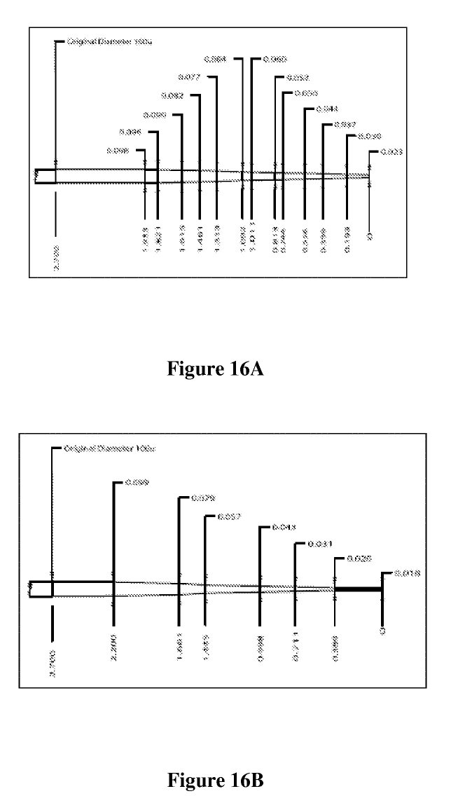

FIGS. 16A and 16B are diagrammatic representations of the completed polish dimensions of two assemblies at each iteration in the cycle. The values along the bottom indicate how much material was removed while the numbers above the taper are aperture dimensions. Aperture sizes did not vary across each array by more than 1μ. Combining the two measurements, diameter and length change, it was possible to produce a profile of the taper created during the drawing process. The assembly represented in FIG. 16A underwent 13 polish cycles which revealed a taper of 1.93 mm long with an angle of 1.11°.

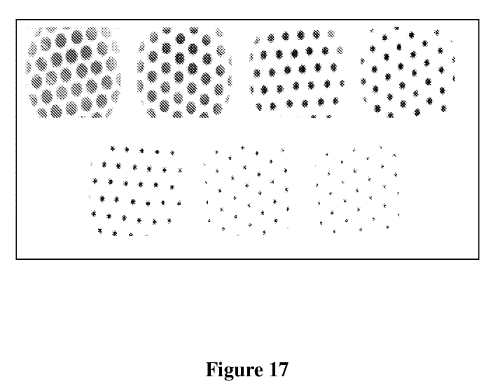

The assembly represented in FIG. 16B had 17 polish cycles performed showing a 2.20 mm taper at an angle of 1.05°. A progression of aperture diameters is shown in FIG. 17 with negative images of the distal face of the assembly illustrated in FIG. 16B.

There are several factors that determine the optical efficiency of a fiber-optic taper. Length, conical angle, smoothness and entry/exit aperture sizes are just a few. This example focused on two goals: structural soundness and a profile that attempts to meet the adiabatic criterion. A structurally sound taper has no cracks, no bends and smooth surfaces with no abrupt changes. As our measurements show, structural soundness was achieved. Attempting to meet the adiabatic criterion, on the other hand, is more complicated.

Adiabaticity, as applied to fiber-optic tapers, typically requires that light proceed through the taper without energy loss due to mode conversion. Energy is lost in a tapering fiber as the field distribution of lower order modes are unable to adjust quickly enough to diameter changes and begin to couple energy to higher order cladding modes. Although light may travel in the cladding for some distance, it is never be regained in the core and as a result, is lost. This mode ‘up-conversion’ can be reduced or even eliminated if the taper angle is sufficiently shallow. Love showed that highly efficient and nearly adiabatic tapers can be achieved if the local taper angle is kept below a critical value. Love, J. D., Henry, W. M., Stewart, W. J., Black, R. J., Lacroix, S., Gonthier, F., “Tapered single-mode fibres and devices, Part 1: Adiabaticity criteria”, Journal of IEE Proceedings, Vol. 138, No. 5, 343-354, 1991. Determining this precise value requires complicated computerized computations of Maxwell's equations and is beyond the scope of this example. However, the angles in the present work are very similar to those shown in Love's work to be nearly lossless.

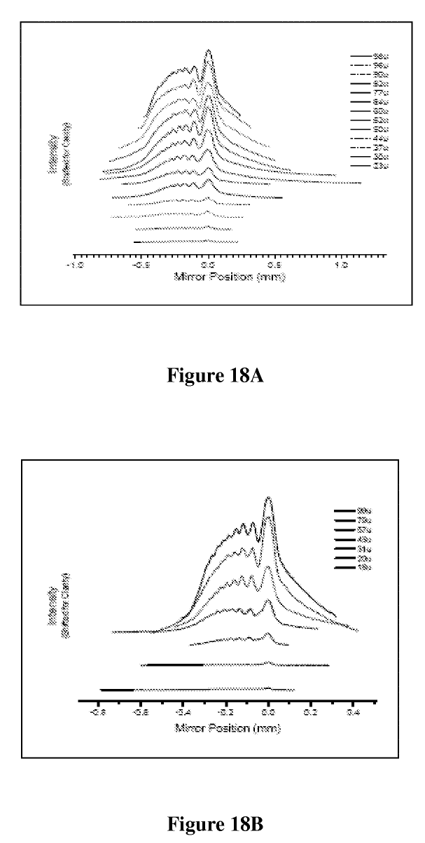

The graph in FIG. 18A combines all of the PSF traces acquired from the assembly illustrated in FIG. 16A and those from FIG. 16B are shown in FIG. 18B. The horizontal axis represents the axial location of the front surface mirror while the vertical axis indicates the intensity level captured by the sensor. For orientation purposes, the objective was located to the left of the graphs and the mirror was normal to the graph plane.

Each trace is shifted vertically for clarity. As expected, the throughput of the system decreases as the apertures are reduced (lower traces) resulting in less signal being returned to the sensor. Both sets of data reveal a decreasing sinusoidal signal returned from axial planes shorter (or left) than the ideal focal plane while those planes long of the focal plane don't exhibit this property.

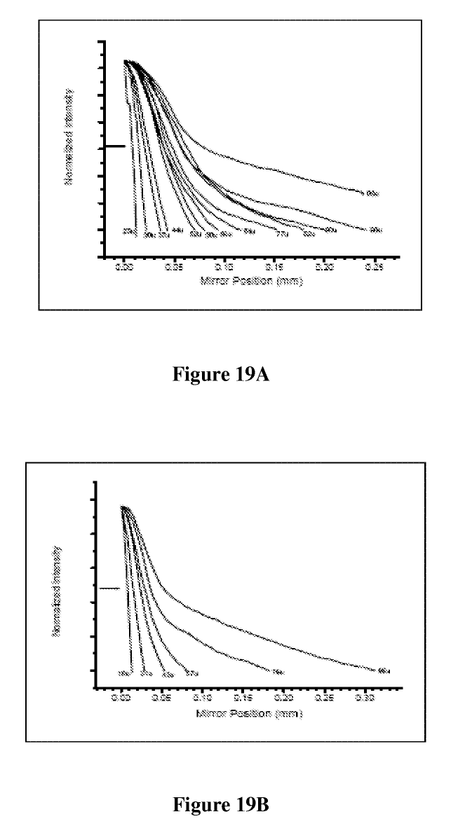

In order to quantify the aperture to section thickness relationship, data from FIGS. 18A and 18B were normalized and are displayed in FIGS. 19A and 19B. Data from the right of the focal plane was used to define section thickness as it is less influenced by spherical aberration and alignment of the optical path. Normalization was performed in the vertical axis to compensate for gain variation at the intensity sensor. As mentioned above, the section thickness for each aperture size was defined as the FWHM point on all traces. Therefore, section thicknesses were measured as double the half-height points (arrows) from FIGS. 19A and 19B.

One would expect that, as the apertures become smaller and the rejection space becomes larger, more light is rejected in all but the confocal plane. This is shown in both sets of normalized PSF curves. FIG. 19B shows a steady regression in thickness as apertures progress from large to small. FIG. 19A reveals the same general progression. The data in FIG. 19A does however, show some response curves (from the larger apertures) overlapping those of smaller (i.e. the 96μ trace and the 90μ trace). This is believed to be caused by a slight misalignment of the mirror during these measurements.

Alignment of the mirror was accomplished by adjusting it all five axis (x, y, z, rotation about x, rotation about y) until maximum signal at the detector was observed. At the larger aperture sizes, light scattering at the distal IG face and mirror made maximum signal acquisition difficult. In other words, at the larger apertures maximum signal would be sensed at many different mirror orientations. Overlapping data does not appear in curves collected from apertures below 50μ as these sizes generate a much thinner peak making it easier to acquire.

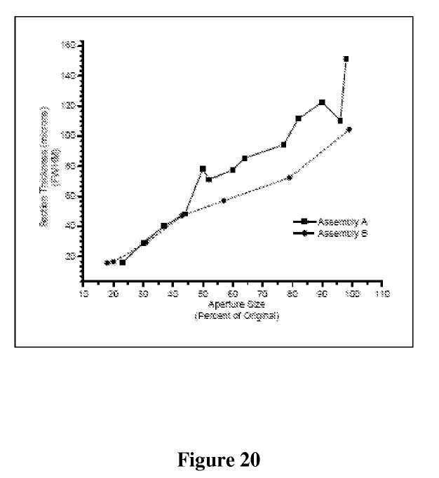

Data comparing sectioning thickness versus aperture diameter are shown in FIG. 20. These data show that the sectioning strength of un-tapered IG (aperture size 100%) is increased predictably with our isolation and drawing process from a high of over 100μ to a minimum of less than 20μ. Both image guides demonstrate a nearly linear relationship between aperture size and section thickness. Achieving this amount of rejection space is encouraging since a ratio (R/Vp) of pinhole spacing R to pinhole size Vp of at least 5 provides acceptable imaging of high contrast samples while allowing acceptable transmissivity through the pinhole plane.

Data show that the agreement of sectioning strengths between assemblies is more highly correlated at aperture sizes below 50μ than above. This is due to the mirror alignment issues mentioned above. Although possessing different taper geometry, i.e. taper angle and taper length, both assemblies produced section thicknesses nearly identical when below 50μ. This suggests that sectioning strength can be accurately controlled by aperture size alone when taper geometries are similar to those presented here.

### EXAMPLE 3

This Example presents the development and application of a tapered-array confocal endoscope (TACE) computerized model. The TACE utilizes a modified fiber-optic image guide to create a confocal pinhole array that eliminates the need for scanning hardware. Results of numerical simulations demonstrate that while ray counts above 100,000 provide highly accurate efficiency calculations, a count of 15,000 is sufficient for general analysis of the point spread function. A scattering ratio of 1.0 with a Gaussian distribution (σ) of 0.25 placed on the target mirror produces results that approximate optical bench data. Predicted optimum spacing between an objective and the array is 10 mm. Taper angle affects both efficiency of the system as well as the magnitude of signal returning from non-focal planes. Shallower angles down to 0.18° add efficiency while those steeper increased non-focal signals. The number of pinholes in the TACE array does not affect section thickness. Additional pinholes increase the size of an acquired image but also increase non-focal noise. A direct relationship was shown between pinhole size and section thickness. TACE model data closely match bench experiments suggesting that the model can be used to predict optical performance.

To develop an understanding of the elements required for full-frame confocal imaging, this Example describes the development and application of a TACE numerical model. The model includes the entire optic train beginning with the proximal end of the IG, propagation through the IG, tapers and objective, and back through the system after front-surface mirror reflection. Initially, the number of rays launched into the IG was investigated to determine the optimum level for producing accurate calculations. Proper spacing between the objective and the array was ascertained. An acceptable degree and location of scattering was determined to best mimic optic bench data. The refined model was then used to examine other features of the TACE system.

Simulations revealed the effect of taper length and angle on the axial point spread function (PSF). Optical bench data suggest that aperture diameter singularly sets section thickness of the TACE. Comparisons between model section data and optical bench data were used to assess model accuracy. The model provides valuable insight into complex optical characteristics of the TACE and is a useful platform to test different parallel imaging designs and parameters.

Model Construction

The TACE model was constructed using Zemax-EE optical modeling software (ZEMAX Development Corporation; Bellevue, Wash., USA). Software selection was based, in part, on the ability to non-sequentially ray trace. Sequential ray tracing originates a ray at the object plane and then alters the ray's path as it encounters optical surfaces traveling in a single direction. Non-sequential tracing allows the rays to strike any object in any order—even striking the same element multiple times. Because a ray will likely strike the walls of a fiber many times, the image guide was modeled as a non-sequential element. The rest of the model remained sequential.

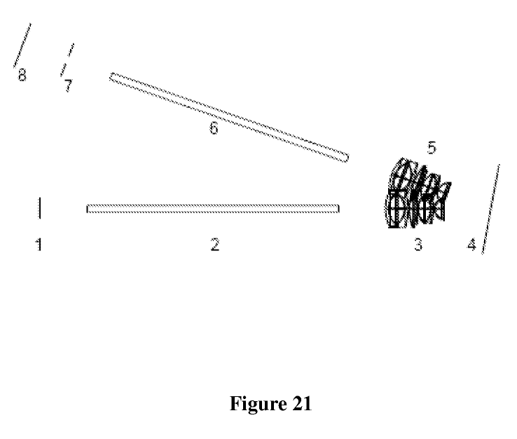

FIG. 21 shows the model layout. Six elements constitute the fundamental structure of the model: entrance pupil, image guide, objective, mirror, exit stop and image plane. Due to direction rules within the model, the objective and image guide were modeled twice, once for the illumination path and once for the sensing (i.e. return) path. Return path elements (items 5,6,7,8 FIG. 21) are rotated upward 20 degrees for clarity. A typical ray path in the model originated at the object plane (not shown), passed the entrance pupil, (1) traveled to the right and entered a fiber in the non-sequential IG bundle (2). At the distal end the ray encountered the fiber tapers.

Upon leaving the non-sequential tapers, rays entered the back of the objective (3) and were bent toward the focal point of the system. When the mirror location coincided with the focal plane, rays reflected back through the objective (5) and re-entered the TACE array through the same aperture from which the rays originated. After re-tracing a route back through the tapers and guide, (6) rays exited and struck the image plane (8).

To prevent oblique rays from striking the image plane (8), a stop (7) was placed a short distance from the IG exit. Such oblique rays were lost in the physical optic train and therefore needed to be removed in the model as well. The objective, was a 3.605 mm focal length apochromatic with a numerical aperture (NA) of 0.95. This simulated objective closely matched the TACE optic bench objective—a Jena apochromat 40× air objective with a 0.95 NA.

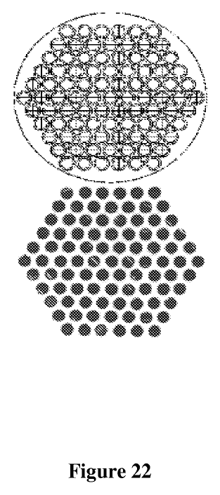

Proximal ends of both the modeled and actual IG are shown in FIG. 22. The figure shows the 91 fibers hexagonally patterned in both image guides. While many thousands of fibers typically comprise an image guide bundle, we chose a 91-fiber ‘macro’ bundle to facilitate visualization and measurement of process effects. A numerical simulation of Schott glass (A87-84) with an NA of 1.48656 was specified for cladding and Schott glass (C06-44) with an NA of 1.6056 was used for the core. Fibers were spaced 130 μm center-to-center with core and cladding diameters of 120 μm and 88 μm respectively. The un-tapered sections of fibers were set to 50 mm long with tapers extending another 3.329 mm. Fiber dimensions and glasses (to the extent reported by the manufacturer) were chosen to match the actual IG used in optic bench experiments. To facilitate experiments using the model, distal taper aperture sizes and all inter-element spacings were designed to be adjustable.

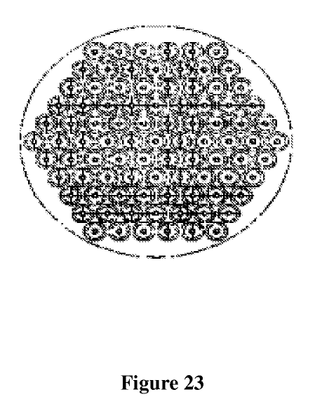

The distal face array of the modeled IG is illustrated in FIG. 23. The large circle surrounding the fiber bundle represents an ‘absorbing volume’ that caused any ray not inside a fiber to quit propagating. To match the optical bench setup, the IG to exit stop distance was set to 10 mm. Since the light source used in all bench-top experiments was a 532 nm diode laser, all rays were set to that wavelength and launched parallel to the optic axis. Parallel rays were achieved by setting the object plane thickness to infinity, i.e. the light source was a single field point located on the z-axis infinitely far away from the entrance pupil. Ray distribution in the entrance pupil was random.

Confocal sectioning performance is often evaluated by translating a front-surface mirror along the z-axis and measuring the light intensity reflected back to the detector. Therefore, the model was designed to simulate that function. Each PSF datum captured at the optic bench consisted of an intensity and mirror-location pair. To replicate intensity measurements in the model, an efficiency ratio (ER) was generated by determining the percentage of rays launched from the object plane that traveled un-vignetted to the image plane. To perform PSF acquisitions in the model, the mirror location was initially set at the distal face of the objective. The ray set was launched into the system and a single efficiency measurement was recorded along with the mirror location. The mirror was then translated a small amount and the process was repeated until the mirror reached its most distal position. In each PSF profile, the z-axis was adjusted so the zero z-value coincided with the focal plane.

Before the model could be used to generate predictive or comparative data, experiments were made to determine various model details. The volume of rays launched into the model was examined to ascertain what affect it had on model performance. Also, the optic bench objective was a standard high-NA 40× model (Jena) typical of those used in scientific microscopes. As the objective location in the optic train was outside of its intended application, the effect of IG-to-objective spacing on throughput and contrast was determined. Lastly, scattering simulations were used to add fidelity to the TACE model.

The variables available for adjustment in all TACE simulations were: taper ratio (tr), fiber to objective distance (fo), ray count (rc), mirror step length (sl), mirror scattering percentage (sp), mirror scattering distribution (σ) and taper length (tl). Taper ratio is the entrance diameter (large end) of the taper divided by the exit diameter (small end); this convention allowed results to be scalable to IG with differing proportions. Fiber to objective distance was always 10 mm except in the experiment where this distance was investigated directly. Ray volume was set to 15,000 for all experiments except save again when rays were themselves investigated. Mirror step lengths were either 1 or 5 μm depending on resolution required.

Ray Volume

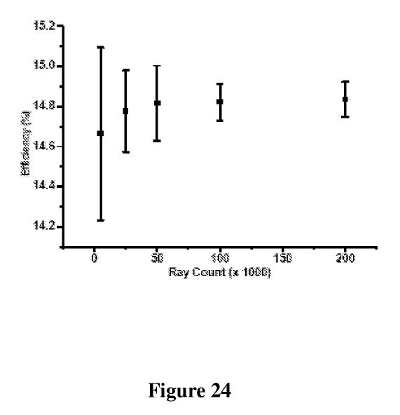

Ray volume experiments were designed to determine how the number of rays affected model variability and accuracy. In one set of ray volume simulations, the number of rays launched into the focused system (mirror at z=0 mm) was adjusted while holding the rest of the model constant. In other words, the same model configuration was used to generate different efficiency ratios (ERs) each with a different volume of rays. Effects of ray volume variation are shown in FIG. 24. Error bar reduction indicates that higher ray volumes produced more precise efficiency measurements.

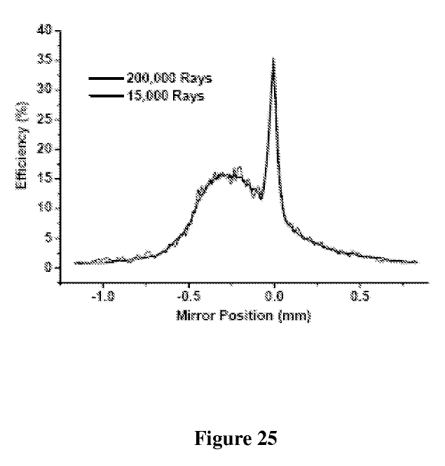

Shown in FIG. 25 is a comparison (efficiency vs. z-axis mirror position) between two PSF profiles, one with 15,000 and the other with 200,000 rays. In this simulation, all model elements were identical except the volume of rays launched from the object plane. Launching 200,000 rays eliminates much of the ‘noise’ seen in the 15,000-ray curve. The computer (Pentium, 2.0 GHz, 512 MB RAM) generated the curve with 15,000 rays in 2 hours whereas the 200,000 ray simulation required 16 hours.

Image Guide to Objective Distance

PSF curves from model IG-to-objective experiments are shown in FIG. 6 where each curve is labeled on the left with IG-to-objective spacing. The distal peak (rightmost) in each curve represents the focal plane for the system in that particular configuration. Arrows indicate peak efficiency at each focal plane.

These data show that distance between IG and objective affect PSF properties. Maximum focal plane efficiency was generated with spacing set to 10 mm and decreased for spacings above and below this value. When spacing was set to 1 mm, the focal peak actually dropped below the two major peaks at 0.25 and 1.5 mm. The working distance appeared inversely related to the IG-objective spacing.

This is as predicted by the standard lens equation:

$$\frac{1}{{s}^{′}} + \frac{1}{s} = \frac{1}{f}$$

where s′ is the object distance, s is the image distance with f being the focal length of the lens. Because of these results, the image guide to rear objective surface was set to 10 mm.

Scattering

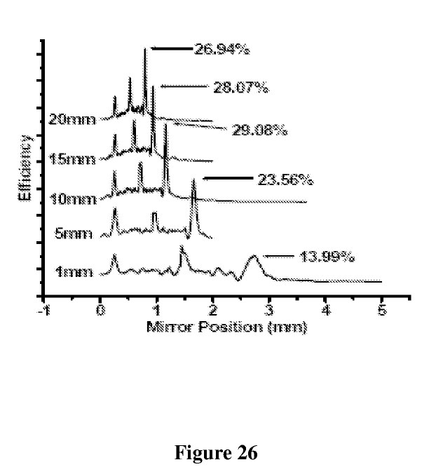

Dissimilarity of PSF curves from model (FIG. 26) and optic bench (FIG. 8) suggested that the model required a degree of ray scattering. The Zemax scattering function, when applied to a surface, deviates a ray from its normal refraction by a randomized value. The percentage of rays that are re-directed is adjustable between 0 and 100% and statistical distribution of re-direction is set by a sigma (10⁻¹⁵-4.0). As the optic bench source was a laser, a Gaussian distribution was selected for scattering. Trials were therefore performed to determine the scattering configuration needed to produce PSF curves similar to those from the optic bench. Because of processing constraints (discussed below), scattering was applied as a lumped parameter on the mirror surface.

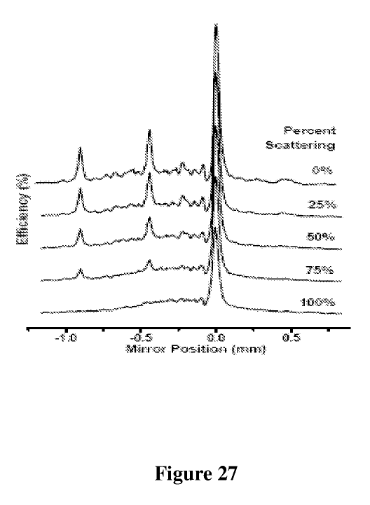

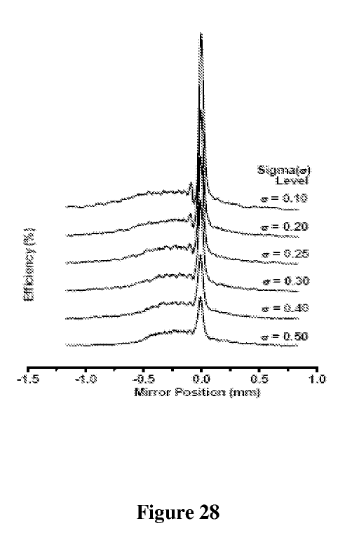

FIGS. 27 and 28 show scattering experiment results. Scattering percentage PSF curves (FIG. 27) are shifted vertically for clarity, and have their percentage level indicated at right. For each trial, all other model parameters were held constant. Trials in which σ was varied (FIG. 28) are also shifted vertically with s values indicated to the right of traces.

Although determining the best scattering parameters was somewhat of a circular task, FIGS. 27 and 28 show the overall effect of each variable. Criterion for percentage selection was elimination of the two significant peaks proximal of the focal plane (˜−0.45 and ˜−0.85 mm, top waveform, FIG. 27) as these peaks do not appear in optic bench data. This dictated a scattering percentage of 100%. Criteria for proper σ level were the appearance of the peak at ˜1.1 mm and its maximum value exceeding that of the rest of the non-focal profile. These criteria indicated that the best configuration for sigma was 0.25.

Experiments

Taper Length

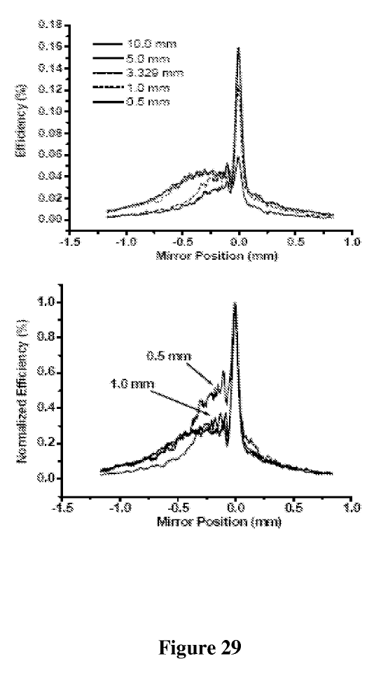

The first TACE simulation, after model variables were set, examined the effect of taper length on performance. Previously, it has been reported that the throughput of a fiber-optic taper is maximized when its sidewall angle is as small as possible. The taper length test examined taper angle effects as well as verified that the model predicted this phenomenon. A simulated PSF profile for each taper length shown in Table 1 was generated (FIG. 29). Sidewall angles corresponding to each length are also shown in Table 1. The 3.329 mm taper length coincided with physical assembly measurements. To isolate the effect of taper length, entrance and exit taper apertures were not changed. Effects on throughput were investigated by comparing peak efficiency at each length. Magnitude of non-focal signals were examined by normalizing the data in the vertical axis.

Pinhole Count

A pinhole count experiment was conducted to determine sensitivity of the TACE section thickness to number of pinholes. Section thickness is sensitive to pinhole count if there is crosstalk between pixels at the focal plane. Crosstalk in a confocal pinhole array arises when the image of an illumination pinhole returns to the array out-of-focus enough that its outer edge reaches a neighboring pinhole. In addition, the NA of each tapered fiber complicates the relationship between neighboring pinholes in the TACE. Optical fiber NA dictates that any light entering at an angle greater than a ‘critical angle’ will not conduct down the fiber and is lost. Therefore, light from one pinhole may or may not enter its neighboring pinholes depending on its return angle.

The experiment consisted of reducing the number of array pinholes in successive simulations thereby reducing routes that out-of-focus light could follow back to the detector. Six PSF curves were acquired beginning with a baseline curve (no apertures covered) and then successively removing outer hexagonal rings. The final curve was that resulting from a single fiber. To remove apertures, a hexagonal stop was placed in the model at the distal surfaces of elements 2 and 6 (FIG. 21). To examine effects of pinhole count adjustment, the six PSF profiles were normalized in the vertical axis.

TABLE 1
Taper sizes in length simulation.

| Taper | Sidewall |
|---|---|
| Length | Angle |
| 0.5 mm | 1.121° |
| 1.0 mm | 0.560° |
| 3.329 mm | 0.183° |
| 5.0 mm | 0.112° |
| 10.0 mm | 0.056° |

Respective sidewall angles shown on right.

Taper Ratio

All confocal instruments face a tradeoff between section thickness and illumination throughput. Smaller pinholes produce thinner sections but pass less light. Understanding the causal relationship between pinhole size and section thickness is important to finding the balance between these two constraints. To examine the effect of taper ratio on section thickness, PSFs were generated at various exit diameters of each taper. The core/cladding ratio along with taper lengths were held constant. Simulations performed with a series of increasing taper ratios were compared to optic bench generated PSFs of corresponding ratios to verify model fidelity. Vertically normalized data showed section thickness changes and non-focal plane noise. Section thickness measurements in this series were double the half-height half-width points of the normalized curves distal of the focal plane.

Results

Taper Length

PSF profiles in which taper length was varied are shown in FIG. 29 where efficiency is plotted versus mirror position. Efficiency effects are revealed in raw data (FIG. 29, top); section thickness and non-focal plane noise are highlighted in normalized data (FIG. 29, bottom). The legend indicates each curve's corresponding taper length.

Profiles (FIG. 29, top) show that efficiency at the focal plane (z=0 mm mirror position) increases as tapers lengthen. In other words, shortening the length of the taper and thereby increasing the side angle does in fact reduce taper efficiency. The longer taper lengths (above 1 mm) generated nearly identical profiles. The curves at the bottom of FIG. 29 reveal that changing the length/angle of the taper does not affect section thickness. This is evidenced by nearly identical half-maximum widths of normalized responses in the focal plane region. The more pronounced effect of taper angle variation appears in the out-of-focus proximal region (mirror position <−0.10 mm). The normalized data show that shorter taper lengths (0.5 and 1.0 mm) generate a larger relative signal in this non-focal area.

Pinhole Count

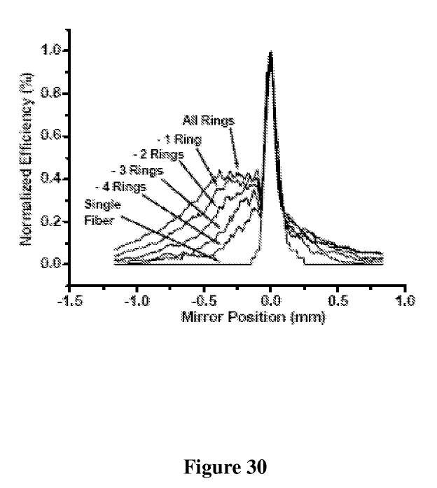

Blocking out successive outer rings of simulated fibers produced the profiles in FIG. 30. The six normalized PSF curves are each indicated by the number of rings blocked relative to the original 91 element hexagonal bundle shown in FIG. 23. Section thickness equivalency of each trial clearly illustrates that section thickness generated by the TACE does not depend on array pinhole count. Affected however, are out-of-focus regions for each curve. Additional pinholes clearly add signal intensity both proximal (<−0.10 mm) and distal (>0.10 mm) of the focal region. The out-of-focus response is much higher proximally than distally. The addition of pinholes not only adds intensity to the unwanted portion of the signal but also widens the overall width of the PSF back toward the objective.

Taper Ratio

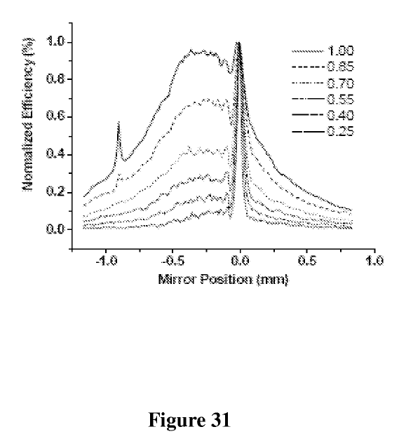

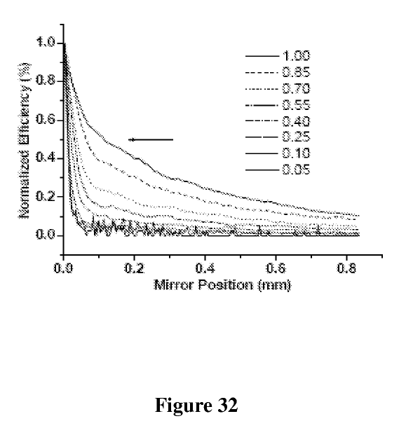

PSF profiles from six different taper ratios are shown in FIG. 31. Below a taper ratio of 0.25 the non-focal plane efficiencies were less than the noise in the system and therefore are not shown. As taper ratio increased, the throughput in out-of-focus regions also increased. Conversely, smaller apertures rejected substantial out-of-focus light. The model predicts that PSF responses from the two largest apertures (un-tapered and 0.85) produce the secondary proximal peak seen in FIG. 24 at approximately the −0.85 mm axial position. To isolate sectioning strength predicted by the conscope model, FIG. 32 shows those normalized data from the distal (right) side of the focal plane. Section thickness is measured from this graph by doubling the curve width at half-height (arrow). FIG. 32 clearly shows a consistent decrease in section thickness at the half-height point as apertures size decreases.

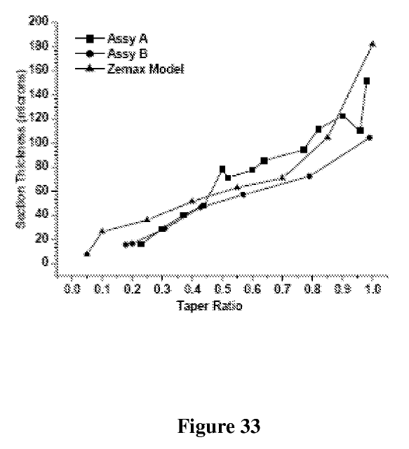

Simulated section thicknesses are compared to those measured from two optical bench assemblies in FIG. 33. Section thicknesses (in microns) are shown as a function of taper ratio. Table 2 lists section thicknesses predicted by the TACE model. While model prediction is accurate, thicknesses simulated between ratios of approximately 0.45 and 0.90 actually fall between those measured at the optical bench.

TABLE 2
Section thicknesses generated by the series of taper ratio simulations.

| Taper | Section |
|---|---|
| Ratio | Thickness |
| 1.0 | 182.0 |
| 0.85 | 104.4 |
| 0.70 | 70.7 |
| 0.55 | 63.1 |
| 0.40 | 51.6 |
| 0.25 | 36.0 |
| 0.10 | 26.5 |
| 0.05 | 7.7 |

Thickness are in microns.

Discussion

Model Construction

Several points about TACE model construction are worth noting. Each simulation began by launching a set of rays from the object plane randomly towards the system entrance pupil. The number of rays in this set defines the denominator for the efficiency ratio calculated at the image plane. That ratio (with mirror position) then constituted a single datum in any of the PSF curves generated by the model. Therefore, the number of rays launched into the entrance pupil directly affects model PSF accuracy.

Effects of ray count variation are shown in FIGS. 24 and 25. FIG. 24 shows that ray count and ER accuracy are directly related. ER variation arises even with all model elements held constant because of the randomness of ray location in the entrance pupil as well as the mirror scattering function. Higher counts reduce ER variation because they approach the geometrical relationship of vignetted space versus clear space in the system—which is a constant. Computational time required to process higher counts can be significant however. FIG. 25 shows that although not an exact replication of the curve generated with 200,000 rays, the 15,000 ray representation conveys its overall properties and more importantly, the section thicknesses of the two are nearly identical.

Objectives such as the one used at the TACE optic bench or its simulated version are typically designed to produce an intermediate image approximately 160 mm from the back of the lens. TACE configuration requires the lens be located at a much shorter distance. Alternative intermediate image placements are possible with objectives albeit with a sacrifice in aberration correction. Proper placement of the objective in the TACE system is a balance between illumination and sensing geometries. Maximal illumination throughput between the array and the objective is achieved when the two are actually in contact, i.e. their separation distance is zero. Less illumination light is captured by the objective as it is moved away from the IG distal face. Efficient transfer of light from objective back into the array (i.e. sensing) is achieved by placing the objective so that the maximum off-axis angle of any ray leaving the objective is less than the tapered fibers acceptance cone.

The effect of tipping the balance of these two geometries one way or the other is shown in FIG. 26. At objective-array spacings more than 10 mm, the peak efficiency at the focal plane slowly drops as the objective is capturing less illumination. Spacings less than 10 mm show rays returning from the objective beginning to exceed the acceptance cones with dramatic loss at 1 mm spacing. Ideal placement of any objective in the TACE system will therefore need to be in a location that will maximize throughput in both directions.

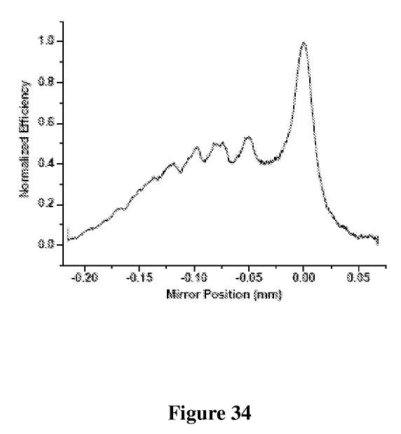

Fine-tuning of model scattering provided significant insight into possible foundations of optic bench properties. Without scattering, PSF profiles similar to the 0% waveform (top) in FIG. 27 were generated by the model. Examination of ray contact patterns (data not shown) on the array face reveal that the secondary peaks (˜0.45 and ˜−0.85 mm, FIG. 27) are caused by highly organized (un-scattered) rays aligning with the array pattern. Secondary peaks, as in FIG. 27, do not appear in data acquired from the optical bench (FIG. 34). This is likely due to absence of perfect element alignment and surface quality.

PSF waveforms appeared similar to those from the optic bench with a scattering percentage of 100% placed on the mirror. Attempts to distribute modeled scattering across multiple surfaces, as that would be more realistic, extended processing time to an unacceptable level. A series of peaks on the proximal side of the focal plane can be seen in optic bench data (FIG. 34). As they approached the objective, each peak became smaller in magnitude. This property of the optic bench data suggested a σ setting of 0.25 (FIG. 28).

It is interesting to note that zero scattering produced the top PSF profile in FIG. 27. The curve represents an almost ideal confocal profile from the focal plane (0.0 mm) back to the secondary peak (˜−0.45 mm). Although the system that generated this profile is perfectly aligned with no scattering, it does suggest that if scattering can be significantly reduced and alignment improved, the TACE could perform confocally to a depth of nearly 500 μm. Scattering adjustments show the model possesses capabilities of reproducing fine optical bench details such as alignment and surface quality.

Model improvements in the future could include glass selection, taper profile, and binding material. The image guide initially selected for the project was a leachable version manufactured by Schott Fiber Optics (Southbridge, Mass.). Since this IG is a proprietary product, exact information is not available regarding indices of refraction. Glass parameters in the current model are based on approximate refraction indices provided by Schott. Determination of precise indices either experimentally or otherwise could provide additional model fidelity.

Regarding taper profile, simple geometric shapes were initially used to define image guide elements (core, cladding, tapers). These geometric simplifications have allowed the model to produce acceptable predictive data. However, since the actual taper profile is a third order complex shape, implementing the taper using the complex geometric capabilities of Zemax could add subtle improvements to model performance.

Binding material between fibers in a finished TACE assembly transitions between original glass binder (i.e. proximal of the tapers) and opaque epoxy added for strengthening. Any ray currently finding its way out of the simulated cladding simply ceases to propagate due to the presence of the ‘ABSORB’ material. Replacing the global absorbing cylinder with precisely modeled binders whose values match the physical materials could improve simulated fiber interactions. Ultimately, the flexibility of the modeling software will allow continual improvements in model accuracy as new information becomes available.

Taper Length

Optical processes occurring at the taper can be important to optimal TACE function. In one direction, (proximal to distal) tapers funnel a large volume of illumination down to pinhole light sources. In the other direction, (distal to proximal) tapers reject light originating from non-focal image planes. How well the tapers perform these two jobs somewhat dictates TACE imaging performance. Specifically, taper length (i.e. taper sidewall angle) can affect illumination efficiency.

Adiabaticity is the goal of every well-behaved optical fiber taper. Adiabaticity specifies that taper angle is small enough everywhere to ensure that there is negligible power loss from the fundamental mode as it travels along the taper's length. In other words, the longer a taper is, the smaller the sidewall angle and shallow sidewall angles allow propagating light waves to adjust to changing taper diameter without coupling to higher modes that are then lost in the cladding. This makes sense, as a very long taper is almost no taper at all. While true adiabaticity depends on wavelength, fiber diameter, cladding thickness, indexes of refraction, etc, a general statement can be that, as tapers go, ‘longer is better’ for illumination.

Un-normalized PSF profiles from taper length simulations (FIG. 29, top) suggest that the TACE model duplicates the adiabatic length phenomenon but that is not the case. Ray trace modeling software cannot replicate light wave modal interactions. The decrease in efficiency magnitude at the focal plane for shorter simulated tapers is likely due to an increased number of rays failing to totally-internally-reflect along the taper because of the steeper wall angle. One can imagine as the taper length approaches zero, many rays will encounter a mirror instead of an exit opening. In actual operation, taper performance would include geometric losses predicted by the model as well as those resulting from the complex modal interactions along the taper.

Interestingly there appears to be a length below which non-focal plane signal relative to focal plane signal rises dramatically. At an unknown length between 1.0 mm and 3.329 mm, the relative non-focal plane signal no longer increases. However, lengths beyond this value continue to increase the focal peak efficiency slightly. If required, the robust drawing processes developed for this project could produce tapers as long as the endoscope itself.

Pinhole Count

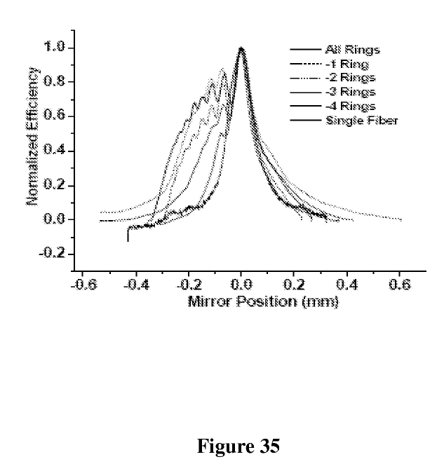

The effect of pinhole count on non-focal plane areas of the TACE PSF is substantial (FIG. 30). The addition of pinholes does not affect section thickness but rather increases signal magnitude originating from non-focal planes. This effect on out-of-focus signals in the model is very similar to that observed in a similar optic bench experiment (FIG. 35). Although not identical, comparison of the two graphs suggests the model simulates this TACE property. The exact cause of excess signal in non-focal planes is not yet known. Previous research suggests that some of this signal is likely due to spherical aberration in the system. Adjustment of model scattering properties suggests that element surface quality may contribute to the out-of-focus signal as well.

Another possible component is some degree of crosstalk between apertures. Increase in simulated out-of-focus signal appears limited as additional pinholes continually increase profile width (predominantly in the proximal direction) but do not continue to add efficiency magnitude.

Taper Ratio

Taper ratio trials reveal a direct relationship between aperture diameter and section thickness. Due to leachable image guide structure, taper ratio not only specifies pinhole diameter, but the ratio also defines space between apertures. Taper ratio and pinhole count trials suggest that while pinhole size defines section thickness, space between pinholes prevents crosstalk.

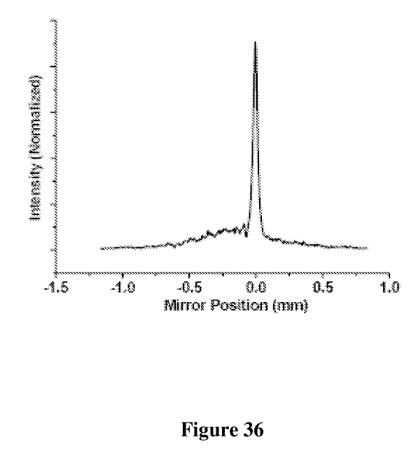

Fewer suggested that a 10 to 1 ratio of pinhole spacing to pinhole radius creates acceptable confocal performance. Fewer, D. T., Hewlett, S. J., McCabe, E. M., and Hagerty, J. “Direct-view microscopy: experimental investigation of the dependence of the optical sectioning characteristics on pinhole-array configuration,” J. Microsc (Oxford) 1997, 187, 54-61. The simulated 0.25 taper ratio configuration (FIG. 36) has a pinhole spacing to radius ratio of 8.85. Although this ratio is not quite as high as Fewer suggested, FIG. 36 shows the degree of out-of-focus light rejection to be significant. Fewer developed his target ratio in context of Nipkow style pinhole disks so it was a compromise between sectioning strength and illumination throughput.

TACE construction likely provides that a ratio of 8.85 may be sufficient since the proximal array (designed to maximize throughput) dictates TACE illumination efficiency. In other words, TACE sectioning strength is very similar to that proposed by Fewer but TACE illumination capability is much higher. Of particular interest in TACE pinhole array characterization are the acceptance cones at each taper opening. An un-tapered optical fiber has an acceptance cone defined by:

$${N}_{0} sin {θ}_{max} = \sqrt{{N}_{1}^{2} - {N}_{2}^{2}} \qquad [ 4 ]$$

where N₀ is the entrance medium index of refraction (usually air), θₘₐₓ is the critical angle of light acceptance and N₁ and N₂ are indexes of refraction for core and cladding respectively. A taper formed at the end of a fiber can be thought of as an NA converter. This conversion aspect of tapers is guided by the equation:

NAₒ=R×NAᵢ [5]

where NA₀ is the entrance numerical aperture, NAᵢ is the exit numerical aperture and R is the ratio of taper input diameter to output diameter. The effect of this relationship in a TACE taper is a widening (i.e. opening) of the fiber's original acceptance cone. Unlike the pinhole in a typical confocal aperture, taper openings selectively allow light to enter. Light that exceeds θₘₐₓ does not remain in the fiber and is rejected. Hence, taper acceptance cones likely act as crosstalk preventers.

An avenue of TACE improvement would be alternate IG indexes of refraction for core and cladding. Fiber manufacturers typically try to maximize the NA (i.e. acceptance angle) thereby increasing off-angle light acceptance. If a leachable image bundle could be obtained with either higher core index or lower cladding index, a smaller NA would be produced. In context of the TACE, a smaller acceptance angle could reduce crosstalk, and possibly section thickness.

### CONCLUSION

TACE model ray counts above 100,000 can provide highly accurate efficiency calculations although a count of 15,000 was sufficient for general PSF information and consumed significantly less computation time. Analysis of the simulated objective's effect on model efficiency shows its distance from the array affects system throughput and an optimum location is predictable. Addition of scattering to the mirror surface allows the model to generate PSF profiles with properties similar to those acquired from the optical bench. Scattering adjustment suggests that non-focal plane signal may be reduced in the TACE by assuring precise alignment and highly polished IG surfaces.

TACE section thickness is not affected by taper length. Shorter tapers do however increase the level of non-focal plane signal. While increasing taper length improves throughput at the focal plane, there appears to be a critical taper length value, beyond which very little difference in PSF profile is observed. Taper ratio simulations show that the aperture spacing to radius ratio is a significant factor in determining section thickness. There also appears to be a nearly one-to-one relationship between aperture diameter and section thickness. Increasing the number of pinholes adds to the non-focal plane signal, but it does so at a limited rate. The resemblance between results of taper ratio simulations and optic bench data suggest that the model can be used to accurately predict TACE optical performance.

It is to be understood that the above discussion provides a detailed description of various embodiments. The above descriptions will enable those skilled in the art to make many departures from the particular examples described above to provide apparatuses constructed in accordance with the present disclosure. The embodiments are illustrative, and not intended to limit the scope of the present disclosure. The scope of the present disclosure is rather to be determined by the scope of the claims as issued and equivalents thereto.

What is claimed is:

1. An image guide comprising a plurality of fiber optic strands, the fiber optic strands being sufficiently spaced apart, or having a suitably small diameter, to simultaneously allow each of the plurality of fiber optic strands to serve as a transmission aperture and a confocal reception aperture.

2. The image guide of claim 1, wherein spaces between fibers are filled with a rigid material.

3. The image guide of claim 2, wherein the rigid material comprises epoxy.

4. The image guide of claim 2, wherein the rigid material is opaque.

5. The image guide of claim 2, wherein the rigid material is sufficiently opaque to prevent out of focus light from entering the aperture.

6. The image guide of claim 1, wherein the plurality of fiber optic strands are encased in a rigid material.

7. The image guide of claim 6, wherein the rigid material comprises stainless steel.

8. The image guide of claim 6, wherein the rigid material comprises epoxy.

9. The image guide of claim 1, wherein the plurality of fiber optic strands are potted in a housing.

10. An image guide formation method comprising:
in an image guide comprising a plurality of fiber optic strands having a center-to-center spacing, mobilizing at least a portion of the plurality of fiber optic strands;
heating a portion of the image guide comprising the at least a portion of fiber optic strands until the strands achieve a plastic state;
pulling the first or second side end relative to the center of the heated portion of the image guide such that the diameter of each of the plurality of strands in the heated portion is reduced while at least substantially maintaining the center-to-center spacing of the strands;
cooling the image guide; and
radially cutting the drawn portion.

11. The method of claim 10, further comprising, after cooling the image guide, encasing fibers in the drawn portion in a rigid material.

12. The method of claim 11, wherein the rigid material is epoxy.

13. The method of claim 11, wherein the rigid material is opaque.

14. The method of claim 11, further comprising grinding distal ends of the strands to provide a desired aperture size.

15. An imaging device comprising:
an image guide comprising a plurality of fiber optic strands, the fiber optic strands being sufficiently spaced apart, or having a suitably small diameter, to simultaneously allow each of the plurality of fiber optic strands to serve as a transmission aperture and a confocal reception aperture;
an illumination source in communication with a proximal end of the image guide;
an objective in communication with a distal end of the image guide; and
a detector in communication with the proximal end of the image guide.

16. The imaging device of claim 15, further comprising a path discriminator intermediate the detector and the image guide.

17. The imaging device of claim 15, further comprising a processor in communication with the detector.

18. The imaging device of claim 15, further comprising an opaque support material disposed between each of the fibers.

19. The imaging device of claim 15, wherein the image guide is enclosed in a flexible, mechanically rigid housing.

20. The imaging device of claim 19, wherein the housing or image guide defines a channel, the channel configured to receive a surgical instrument.
